(19) United States
(12) Patent Application Publication
(10) Pub. No.: US 2014/0137257 A1
(43) Pub. Date: May 15, 2014

(54) System, Method and Apparatus for Assessing a Risk of One or More Assets Within an Operational Technology Infrastructure

(71) Applicants: Salvador Cordero, Socorro, TX (US); Eduardo Obregon, El Paso, TX (US); Irbis Gallegos, El Paso, TX (US)

(72) Inventors: Ralph Martinez, El Paso, TX (US); Salvador Cordero, Socorro, TX (US); Eduardo Obregon, El Paso, TX (US); Irbis Gallegos, El Paso, TX (US)

(73) Assignee: BOARD OF REGENTS, THE UNIVERSITY OF TEXAS SYSTEM, Austin, TX (US)

(21) Appl. No.: 14/078,514

(22) Filed: Nov. 12, 2013

Related U.S. Application Data
(60) Provisional application No. 61/725,474, filed on Nov. 12, 2012.

(51) Int. Cl. G06F 21/57

(52) U.S. Cl. CPC G06F 21/577
USPC 726/25

(57) ABSTRACT

A system, method and apparatus assesses a risk of one or more assets within an operational technology infrastructure by providing a database containing data relating to the one or more assets, calculating a threat score for the one or more assets using one or more processors communicably coupled to the database, calculating a vulnerability score for the one or more assets using the one or more processors, calculating an impact score for the one or more assets using the one or more processors, and determining the risk of the one or more assets based on the threat score, the vulnerability score and the impact score using the one or more processors.

### CROSS-REFERENCE TO RELATED APPLICATIONS

This application claims priority to U.S. provisional patent application Ser. No. 61/725,474 filed on Nov. 12, 2012 and entitled “System, Method and Apparatus for Assessing a Risk of one or More Assets within an Operational Technology Infrastructure,” the entire contents of which is incorporated herein by reference.

### TECHNICAL FIELD OF THE INVENTION

The present invention relates generally to the field of security assessment system and, more particularly, to a system, method and apparatus for assessing a risk of one or more assets within an operational technology infrastructure.

### STATEMENT OF FEDERALLY FUNDED RESEARCH

None.

### BACKGROUND OF THE INVENTION

As defined by the U.S. National Institute of Standards and Technology (NIST) sponsored Smart Grid Interoperability Panel (SGIP), “Cyber Security” addresses deliberate attacks launched by disgruntled employees, agents of industrial espionage, and international terrorist and crime groups, and inadvertent compromises of the information and operational infrastructure due to user errors and component failures [1N]. Cyber security countermeasures can prevent potential attackers from penetrating information technology (IT) and operational technology (OT) networks, gaining access to control software, and altering conditions to destabilize the control system in unpredictable ways.

Critical sector infrastructure owners are implementing automation of OT to improve the reliability and efficiency of their infrastructures' processes. OT is defined as hardware and software that detects or causes a change through the direct monitoring and/or control of physical devices, processes and events in the enterprise [2N]. OT infrastructure modernization has increased the dependency on information and communication technologies in order to integrate physical parameter measurements and intelligent controller devices. The increased modernization of OT serving critical infrastructures introduces the risk of cyber-based attacks.

Currently, most of the existing standards that support cyber vulnerability assessments and risk management are only applicable to specific sectors, domains, and technologies. For example, the NIST SP 800-30 document is used to conduct threat, vulnerability, and impact analysis to discover cyber security countermeasures for IT systems [3N]. Other standards such as NIST SP 800-82[4N] and ANSI/ISA-99 [5N] address cyber security for industrial control systems (ICS).

However, no standard process exists for vulnerability assessment and risk management for the intersection between IT and OT systems. As a result, there is a need to address such a shortcoming by providing a vulnerability assessment and risk management process that is applicable to a variety of infrastructures and, is able to identify and analyze cyber critical assets, cyber vulnerabilities and cyber threats at the interaction points between IT and OT systems.

### SUMMARY OF THE INVENTION

The present invention provides semi-automated, quantitative processes for conducting cyber security risk assessments to identify and prioritize critical assets, cyber threats, and cyber vulnerabilities for operational technology (OT) infrastructures in critical sectors. More specifically, the Vulnerability Assessment and Risk Management (VARM) process to conduct cyber security risk assessments on national critical sector's infrastructures including, but not limited to, public utilities (e.g. electricity, water, gas), critical manufacturing, healthcare, educational institutions, government facilities, etc. The VARM processes provide a software architecture, common information model, and big data set repository that is retained and owned by the enterprise customer.

The VARM process is able to identify and analyze cyber critical assets, cyber vulnerabilities and cyber threats at the interaction points between IT and OT systems. More specifically, the VARM process provides vulnerability assessment and risk management processes applicable across multiple critical sectors, applies to critical assets served by an operational technology (OT) domain, provides a quantitative approach for threat, vulnerability, and risk determination, is supported by customized software applications and processes, and provides alternate visualizations of the risk profile based on impact factors for mitigation purposes. Moreover, the VARM process provides software architecture for automated data collection, storage, and analytics at each VARM step using a Common Information Model (CIM). The VARM threat, vulnerability and risk data are integrated with the geospatial database of the OT infrastructure. The VARM process provides a near real-time situational awareness of customer critical assets and their vulnerabilities, automated real-time data feeds from national threat databases, and automated large data sets that are owned by the customer.

In one embodiment, the present invention provides a method for assessing a risk of one or more assets within an operational technology infrastructure by providing a database containing data relating to the one or more assets, calculating a threat score for the one or more assets using one or more processors communicably coupled to the database, calculating a vulnerability score for the one or more assets using the one or more processors, calculating an impact score for the one or more assets using the one or more processors, and determining the risk of the one or more assets based on the threat score, the vulnerability score and the impact score using the one or more processors. The foregoing method can be implemented as a computer program embodied on a non-transitory computer readable medium wherein the steps are executed by one or more code segments.

In addition, the present invention provides an apparatus for assessing a risk of one or more assets within an operational technology infrastructure, wherein the apparatus includes a database containing data relating to the one or more assets, and one or more processors communicably coupled to the database. The one or more processors calculate a threat score for the one or more assets, calculate a vulnerability score for the one or more assets, calculate an impact score for the one or more assets, and determine the risk of the one or more assets based on the threat score, the vulnerability score and the impact score.

Moreover, the present invention provides a system for assessing a risk of one or more assets within an operational technology infrastructure. The system includes a risk assessment subsystem that calculates a threat score for the one or more assets, calculates a vulnerability score for the one or more assets, calculates an impact score for the one or more assets, and determines the risk of the one or more assets based on the threat score, the vulnerability score and the impact score. The system also includes a risk visualization subsystem, a risk mitigation subsystem, and a controller communicably coupled to the risk assessment subsystem, the risk visualization subsystem and the risk mitigation subsystem.

The present invention is described in detail below with reference to the accompanying drawings.

### BRIEF DESCRIPTION OF THE DRAWINGS

The above and further advantages of the invention may be better understood by referring to the following description in conjunction with the accompanying drawings, in which:

FIG. 1 is a flow chart showing the four main steps for the VARM process with impact analysis in accordance with one embodiment of the present invention;

FIG. 2 is a block diagram illustrating the architecture of a modern electric power grid 200;

FIG. 3 is a flow chart showing the system characterization process in accordance with one embodiment of the present invention;

FIG. 4 is a flow chart showing the system characterization process in accordance with another embodiment of the present invention;

FIG. 5 is a diagram showing four areas of cyber/physical security categories in accordance with one embodiment of the present invention;

FIG. 6 is a flow chart showing the threat assessment process in accordance with one embodiment of the present invention;

FIG. 7 is a flow chart showing the vulnerability assessment process in accordance with one embodiment of the present invention;

FIG. 8 is a diagram showing the NESCOR Penetration Test Plan;

FIG. 9 is a diagram showing the CVSS Metric Groups;

FIG. 10 is a flow chart showing the risk determination process in accordance with one embodiment of the present invention;

FIG. 11 is a diagram showing the development of a risk scenario in accordance with one embodiment of the present invention;

FIG. 12 is diagram showing a software architecture suitable for supporting the VARM process in accordance with one embodiment of the present invention; and

FIG. 13 is a block diagram showing the software support for the critical infrastructure analysis process in accordance with one embodiment of the present invention;

FIG. 14 is a block diagram showing the software support for the threat analysis process in accordance with one embodiment of the present invention;

FIG. 15 is a block diagram showing the software support for the vulnerability assessment process in accordance with one embodiment of the present invention;

FIG. 16 is a block diagram showing the software support for the impact analysis process in accordance with one embodiment of the present invention;

FIG. 17 is a block diagram showing the software support for the risk determination process in accordance with one embodiment of the present invention;

FIGS. 18A and 18B depict an example of a geospatial visualization of risk factors for the critical assets in accordance with one embodiment of the present invention;

FIG. 19 is a flow chart of the VARM process in accordance with another embodiment of the present invention;

FIG. 20 is a flow chart showing the system characterization process in accordance with another embodiment of the present invention;

FIG. 21 is a block diagram of a typical component configuration of an OT infrastructure in accordance with another embodiment of the present invention;

FIG. 22 is a block diagram of a critical operational technology example for a solar-powered system enterprise in accordance with another embodiment of the present invention;

FIG. 23 is a criticality interconnection map example for a solar powered system enterprise in accordance with another embodiment of the present invention;

FIG. 24 is a flow chart showing the vulnerability assessment process in accordance with another embodiment of the present invention;

FIG. 25 illustrates a vulnerability distribution in accordance with another embodiment of the present invention;

FIG. 26 is a flow chart showing the threat assessment process in accordance with another embodiment of the present invention;

FIG. 27 is a flow chart showing the risk determination process in accordance with another embodiment of the present invention;

FIG. 28 is a flow chart showing the development of a risk for a critical asset in accordance with another embodiment of the present invention;

FIG. 29 is a graph illustrating the risk dependence on impact, vulnerability and threat values in accordance with another embodiment of the present invention;

FIG. 30 is a graph for risk mitigation importance in accordance with another embodiment of the present invention; and

FIG. 31 is a block diagram of a software architecture to support the VARM process in accordance with another embodiment of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

The present invention provides an automated detailed process for identifying, prioritizing, and estimating risks by analyzing cyber threat and vulnerability information to determine the extent to which cyber circumstances or events could adversely impact a critical asset. Risk mitigation visualization is generated to document the results of the assessment once a risk assessment is conducted.

As used herein, risk is a function of: (1) a “cyber threat” exercising a set of potential “cyber vulnerabilities” on a set of “critical cyber assets” (CCA) supporting a “critical asset” (CA); and (2) the resulting impact of the vulnerability compromise(s) on such critical asset (CA). A “cyber threat” is any circumstance or event with the potential for a “threat source” to successfully compromise any exposed cyber vulnerabilities. A “threat source” is defined as a potential source, either human or technological, with the motivation, capability, and intent to cause harm to an infrastructure. “Vulnerability” is an inherent weakness in a critical cyber asset that could be exploited by a threat source. “Critical cyber assets” are network routable electronic components that are part of control or data acquisition systems that monitor, manage or command operational equipment. A “critical asset” is defined as a physical component essential to the operation of the infrastructure. “Impact” is the magnitude of disruption that can be expected in terms of safety, economic, and mission to the infrastructure if critical asset is compromised.

The VARM process described herein can be applied to conduct risk assessment of critical infrastructure for public utilities (e.g., electricity, water, gas), national critical infrastructure protection (CIP) assets as defined by the United States Department of Homeland Security, (e.g., bridges, roads), educational institutions and facilities (e.g., universities), and government agencies in the United States and from other nations. The automated VARM processes provide a software architecture, common information model, and big data set repository that is retained and owned by the enterprise customer.

The VARM process simplifies vulnerability assessment and risk management processes, applies to critical assets in OT (specifically energy systems), addresses threats and vulnerabilities in both information technology (IT) control planes and OT infrastructures, includes an impact analysis at each of the first three steps (as described below) rather than a single impact analysis, and provides a quantitative approach for risk determination based on a summation of weighted variables. Moreover, the VARM process provides software architecture for automated data collection, storage, and analytics at each VARM step using a Common Information Model (CIM). The VARM threat, vulnerability and risk data are integrated with the geospatial database of the OT infrastructure. The VARM process provides a near real-time situational awareness of customer critical assets and their vulnerabilities, automated real-time data feeds from national threat databases, and automated large data sets that are owned by the customer.

The present invention will now be described with respect to two embodiments. The first applies the VARM process to energy systems. The second embodiment applies the VARM process to critical assets for OT infrastructures in general and is not specific to any particular sector, domain, or technology.

The VARM process for energy systems described herein is unique to the utility sectors. The VARM provides a reusable process that streamlines vulnerability assessment and risk management processes, applies to critical assets in OT and IT domains, addresses threats and vulnerabilities in IT planes and OT infrastructures, includes various impact analysis at different stages of the risk analysis process rather than a single impact analysis, provides a quantitative approach for risk determination based on summations of weighted variables, and is supported by a software architecture as shown and described in reference to FIGS. 12-18. The VARM processes apply to several IT/OT environments that require critical infrastructure to operate and provide products and services.

VARM for OT in energy systems is defined as the process of identifying, prioritizing, and estimating risks by analyzing physical and cyber threat and vulnerability information to determine the extent to which physical and cyber circumstances or events could adversely impact a critical asset. Once a risk assessment is conducted, a risk profile is generated to document the results of the risk assessment. Typically only a few risk profiles are generated during the life span of the infrastructure, mostly due to cost and time, thus only a small state of the risk of the infrastructure is captured at a time. Threats and vulnerabilities are uncovered with a higher frequency than what the few risk profiles can capture, thus, the need for a cost and time effective solution to assess risk in energy infrastructures. Risk management is defined as the processes to avoid and mitigate the risks and involves a continuous monitoring the vulnerabilities of the energy grid [1].

Risk is a function of a threat exercising a potential vulnerability on a critical asset, and the resulting impact of that adverse event on the system. A threat is any circumstance or event with the potential for a threat-source to adversely impact operations and assets of a power grid. The threat-source is any form of exploitation that either has (1) an intent and method targeted intentionally or (2) a situation and method that may be accidentally. Vulnerability is an inherent weakness in an information system, security infrastructure, internal control, or implementation that could be exploited by a threat source. A critical asset is defined as an infrastructure component that is of interest to the stakeholder due to its value to the physical or cyber infrastructure, monetary value, or human life-threatening condition. The level of impact from a threat event is the magnitude of harm that can be expected to result from the unauthorized disclosure, modification, disruption, destruction, or loss of information and/or denial of service [1].

Preparation for starting the VARM process involves the following pre-assessment process to ensure an efficient and accurate analysis: (1) Form a well-qualified VARM team that consists of representation from the organization's security, risk management, regulatory compliance, OT, IT and any other member as required; (2) Set scope and objectives to focus and ensure completeness of the VARM; and (3) Gather pre-VARM data to evaluate baseline security (optional).

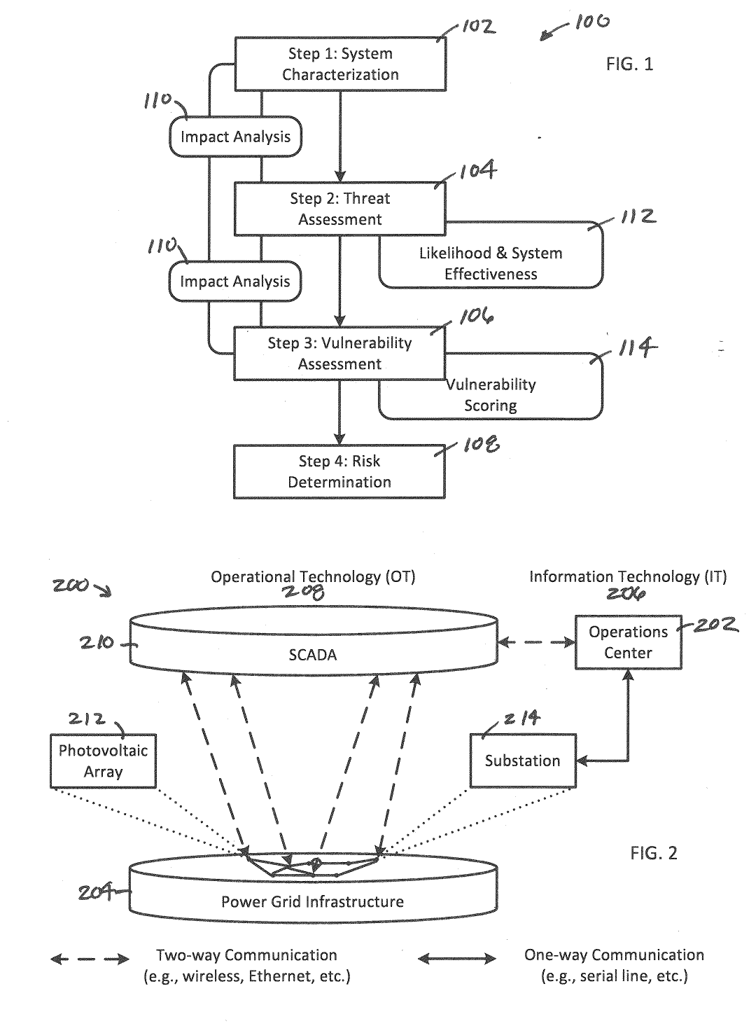

Now referring to FIG. 1, a flow chart showing the four main steps for the VARM process 100 with impact analysis in accordance with one embodiment of the present invention are shown. The VARM process for OT in energy systems consists of four primary steps done throughout the lifecycle of the assessment: System Characterization (Step 1) 102; Threat Analysis (Step 2) 104; Vulnerability Analysis (Step 3) 106; and Risk Determination (Step 4) 108. Impact analysis 110 is a lateral step done in the system characterization 102, threat assessment 104, and vulnerability assessment 106 steps of the VARM process 100. Likelihood & System Effectiveness Scoring 112 is determined as part of the threat assessment 104 step. Vulnerability Scoring 114 is determined as part of the vulnerability assessment 106. These steps will be described in more detail below.

Communications and information technology discovery and sharing with the customer take place, as well as risk assessment management, through the duration of the VARM process. Risk assessment management most of the time is used to provide context for the assessment. The context for the assessment, e.g., information regarding policies and requirements for conducting the risk assessment, specific assessment methodologies to be employed, procedures for selecting risk factors to be considered, scope of the assessments, rigor of analyses, degree of formality, and requirements that facilitate consistent and repeatable risk determinations [1].

Once the VARM is completed, there is the need to provide the recommended cyber security solutions and countermeasures so they can be reviewed and implemented by the customer. Finally, the VARM results are included in a written report that documents the VARM analysis.

The first step 102 in physical and cyber security system analysis is to define the scope of the assessment in order to proceed in identifying the boundaries, resources, and information that constitute the system. The system characterization 102 of energy systems includes the identification of both cyber and physical assets. FIG. 2 illustrates the architecture of a modern electric power grid 200 where you have an operations center 202 that controls the power grid infrastructure 204 through an IT control plane 206 and OT control plane 208. SCADA systems 210 are distributed monitoring and control systems commonly associated with electric power transmission and distribution systems, oil and gas pipelines, and water and sewage systems [7]. The power grid infrastructure 204 may include various domains, such as generation, distribution, operations, and/or customers. The generation components may include coal-fired plant, gas-fired plant, nuclear plant, renewable energy (e.g., photovoltaic array 212), etc. The distribution components may include substations (e.g., substation 214), distribution systems, advanced metering infrastructures etc. The operations components may include data management systems, fixed and RF communication networks, database repositories, etc. The customer components may include smart meters, home management systems, smart appliances, etc. Communications between the power grid infrastructure 204, SCADA 210, operations center 202 and domain components can be one-way communications (e.g., serial line, etc.) or two-way communications (e.g., wireless, Ethernet, etc.).

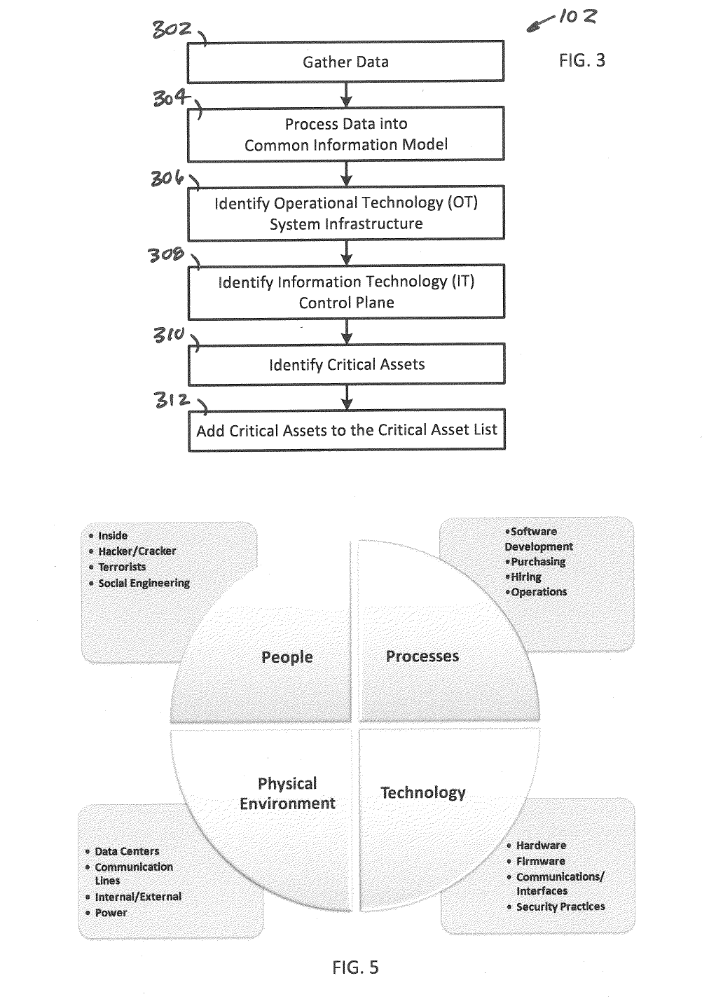

Now referring to FIG. 3, a flow chart of the system characterization process 102 in accordance with one embodiment of the present invention is shown. Data is gathered in block 302 and the data is processed into a CIM in block 304. The OT system infrastructure is identified in block 306 and the IT control plane is identified in block 308. Finally, the critical assets are identified in block 310, and added to the Critical Asset List for further analysis in block 312. These steps will now be described in more detail.

Step 1 (302): The first step in system characterization 102 is to gather data from the customer. This data will be gathered from a customer asset data database or will have to be created. Both cyber and physical assets are considered. Data will be entered and kept in the Integrated Data Repository location for further review. Data for the IT control plane and OT infrastructure will be required to begin the system characterization of the energy grid. Note: Different type of data files might exist for customer data and therefore processing of data will be required as per step 2 (304).

Step 2 (304): The second step in system characterization 102 is to process all institutional files, databases, tables, and other data collected into a CIM. This step is a crucial process for the continuation of the VARM, a common information representation of all the data collected from the customer will be required. Examples of data types provided by the customer can be in the form of: (1) Graphics—jpeg, pdf, png, tif, gif, etc.; (2) Text—txt, doc, xls, latex, dos, etc.; (3) Audio and video—mp3, wave, mpg, abi, etc.; and (4) Other—CAD, ECAD, GIS, Visio, Opnet, etc.

The CIM provides a standard for representing energy system objects along with their attributes and relationships. The CIM facilitates the integration of: Energy Management System (EMS) applications developed by different vendors; entire EMS developed by different vendors; or EMS and other systems concerned with different aspects of power system operations, such as generation or distribution management [23]. The CIM also provides a single, standard, enterprise vocabulary of terms that all energy grid components will share. Data is sent and received between energy components in CIM format. In industry, the current scope of the CIM is to provide standard objects for the inter-operation of systems and applications used for production, transmission, distribution, marketing and retailing functions of electric, water and gas utilities [23]. The VARM software architecture includes data processing modules that further explain the automation.

Step 3 (306): The third step in system characterization 102 is to identify OT for the energy system infrastructure. The OT system infrastructure is identified by obtaining an OT infrastructure topology, categorizing the OT of the energy infrastructure assets into domains, identifying assets for the OT control systems, and categorizing the assets into physical assets or cyber-physical assets.

The OT infrastructure topology can be identified from a variety of diagrams, documentation, and systems. The following are examples of data sources that can help to obtain an infrastructure topology. One-line diagrams are a blueprint for the electrical system that includes cable voltages and sizes, power and control transformers, feeder breakers, switches, relays, and cutouts, etc. The Geographic Information System (GIS) organizes geographic data into a series of layers and tables linked to a location in the globe that can provide raw measurements (imagery), compiled and interpreted information, and geo-processed data for analysis and modeling [8].

The OT of the energy infrastructure assets is categorized into the following domains: generation, distribution, operations, and customers. Generation components may include coal-fired plant, gas-fired plant, nuclear plant, renewable energy etc. Distribution components may include substations, distribution systems, advanced metering infrastructures etc. Operations components may include data management systems, fixed and RF communication networks, database repositories, etc. Customer components may include smart meters, home management systems, smart appliances, etc.

Identifying the assets for the OT control systems requires the identification of the type of communication and control system in place. The communication systems provide the information links needed for the relay and control systems to operate [2]. These systems might be either or a combination of the following communication and control systems. Industrial Control Systems (ICS) operate in all types of infrastructures including electric power grid, water, oil and gas, pipelines, transportation, and manufacturing. ICSs measure, control, and provide a view of processes. These systems include but are not limited to DCSs, PLCs, remote terminal units (RTUs), IEDs, networked electronic sensing and control, and monitoring and diagnostic systems [7]. Supervisory Control and Data Acquisition (SCADA) Systems are distributed monitoring and control systems commonly associated with electric power transmission and distribution systems, oil and gas pipelines, and water and sewage systems [7]. Communications media that might be used for SCADA communications includes advanced radio data information services (ARDIS), cellular telephone data services, digital microwave, fiber optics, multiple address radio (MAS), etc. [2]. The following elements are required in order to characterize the SCADA communication system:

Identification of communication traffic flows—source/destination/quantity

Overall system topology

Identification of end system locations

Device/processor capabilities

Communication session/dialog characteristics

Device addressing schemes

Communication network traffic characteristics

Performance requirements

Timing issues

Application service requirements

Application data formats

Operational requirements

Quantification of electromagnetic interference withstand requirements

Note: This data will be accessed from the secure Integrated Data Storage location. Different types of tools can be utilized for identifying the OT control plane (e.g., Network Discovery Tool, SCADA/Modbus Tool, Network Flow Analysis Tools, etc.).

The assets are categorized into physical assets or cyber-physical assets. Physical assets are any asset that those not have a IP address and/or support any type of communications for operation, control, monitoring, alerting, data acquisition, etc. Cyber-Physical assets are any physical asset that supports functions such as operation, control, monitoring, alerting, data acquisition, etc. Examples of these are EMS, HMI, RTUs, PLCs, and PMUs, etc.

Step 4 (308): The fourth step in system characterization 102 is to identify existing IT control plane. This will require the identification of the type of systems in place that are part of both operational and information technology planes. These are IT enabled assets. The IT control plane systems provide the information links between the control systems and operations center. These systems might be either or a combination of the following systems: (a) Asset management systems; (b) Outage management systems; (c) Weather forecasting systems; (d) Building management systems; (e) Customer information systems; (f) Energy management systems; and (g) Enterprise service bus (ESB) systems.

Step 5 (310): The fifth step in system characterization 102 is to classify assets into critical, critical-cyber and non-critical according to the level of criticality (based on their value to the organization, regulatory requirement, etc.). In this step, the customer supplies a critical asset list. If the critical asset list does not exist, the VARM team will work with customer to generate one. Critical assets can be identified by the following options: (1) evaluate the asset against NERC CIP standards; or (2) perform an impact analysis.

NERC Standard CIP-002-1 requires that applicable entities identify and document a “risk-based” methodology that complies with CIP-002-1 R1 to identify critical assets (i.e., facilities, systems, and equipment) [CIPC, 2009]. First, identify the essential asset functions. Examples of asset functions include: load balancing, voltage support, constraint management, wide-area situation awareness, restoration, system stability, load management, control and operation, etc. Second, identify interdependencies of any internal and external systems/assets that support the operation of the asset. Third, identify countermeasures that protect the asset. All pertinent layers of existing security systems including physical, cyber, operational, administrative, and safety systems will need to be identified. Fourth, estimate severity of loss or damage to asset. Fifth, select critical assets for further analysis.

When identifying critical-cyber assets, NERC Standard CIP-002 R3 requires that entities develop a list of critical cyber assets essential to the operation of its critical assets [CIPC, 2010]. The list of critical cyber assets is developed by: (1) identifying the associated critical asset; (2) identifying if supervisory or autonomous control impacts reliable operation of the critical asset; (3) determining if the critical asset displays, transfers, or contains information on real-time decisions impacting reliable operation of the critical asset; (4) determining if loss, degradation or compromise impacts the reliable operation of the critical asset; (5) identifying if the critical asset communicates with systems outside the electronic security parameter (ESP) using a routable protocol (check if routable protocol is within a control center); and (6) determining if the critical asset is dial-up accessible.

The secondary step impact analysis will also be utilized in determining the criticality of an asset. The impact analysis process will be described below.

Step 6 (312): The sixth step in system characterization is to add critical assets to Critical Asset List for further analysis. Apply general security countermeasures for non-critical assets.

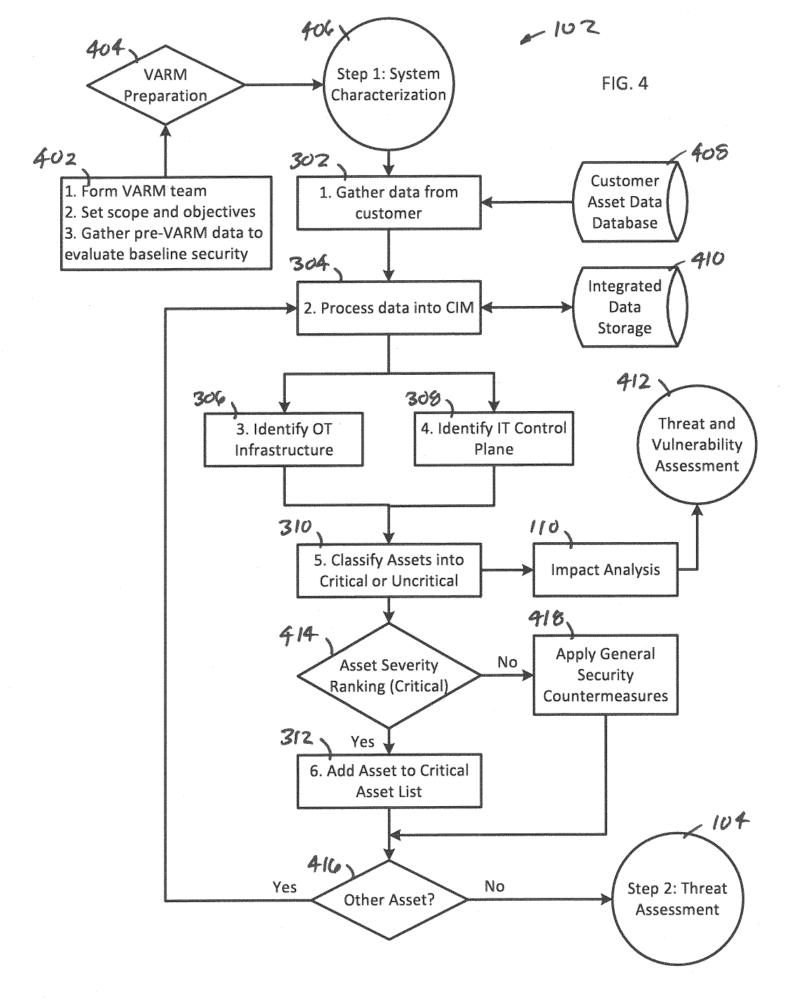

Referring now to FIG. 4, a flow chart of the process for performing the primary step system characterization 102 in accordance with another embodiment of the present invention is shown. The preliminary steps include forming a VARM team, setting a scope and objectives and gathering pre-VARM data to evaluate a baseline security in block 402 and other VARM preparation in block 404. Step 1 (102) System Characterization 102 in the VARM process 100 begins in block 406. Customer data is gathered from a customer asset data database 408 in block 302. The customer data is processed into a CIM stored in integrated data storage 410 in block 304. The OT infrastructure and IT control plane are identified in blocks 306 and 308, respectively. Assets are classified into critical assets or uncritical assets in block 310. An impact analysis 110 and threat and vulnerability assessment 412 are also performed. If the asset severity ranking is critical, as determined in decision block 414, the asset is added to the critical asset list in block 312. If, however, the asset severity ranking is not critical, as determined in decision block 414, general security countermeasures are applied to the asset in block 418. In either case, if other assets remain to be processed, as determined in decision block 416, the process loops back to process data into CIM in block 304 and repeats as previously described. If, however, no other assets remain to be processed, as determined in decision block 416, VARM process step 2 (104) threat assessment is performed.

The impact analysis 110 is a technique design to determine unexpected negative effects of a change on a critical infrastructure; in this case, operational technology in energy systems. This technique provides a structured approach for looking at a threat event and its vulnerability, so that you can identify as many of the negative impacts or consequences of the threat as possible. The level of impact from a threat event is the magnitude of harm that can be expected. Such an unfavorable impact, and hence harm, can be experienced by a variety of critical infrastructures.

Impact analysis 110 is to be applied to steps 1, 2 and 3 of the vulnerability assessment and risk management process. Impact is a function of criticality, threat, and vulnerability. As each step continues, information is fed back to the impact analysis for successful completion, which is shown in FIG. 1 of the VARM process. Quantitative values are calculated for the criticality of an asset through the evaluation of a set of metrics to obtain the impact if the asset is attacked.

First, obtain the metric values for the impact score. Step 1 (102) of the VARM process 100 (system characterization) will be done in order to effectively complete the impact analysis. System characterization will provide input values for determining values for the impact score based on metrics of criticality. The asset should be evaluated by the following metrics shown in Table 1 for calculating the criticality impact score.

TABLE 1
Criticality Impact Scoring Evaluation Metrics

| Metric | | Value |
|---|---|---|
| | Description (DeathImpact) | |
| None (N) | There are no deaths when critical asset is harmed | 0.0 |
| Single/Multiple (SM) | There are a single or multiple deaths when a critical asset | 0.660 |
| | is compromised. Any death automatically gives a high | |
| | criticality impact score of 1.0. | |
| | Description (RepairProtec) | |
| Low (L) | There is a low repairing cost and costs for protecting the | 0.0 |
| | critical asset are low. | |
| Medium (M) | There is a medium repairing cost and cost for protecting | 0.275 |
| | the critical asset are medium. | |
| High (H) | There is a high repairing cost and costs for protecting the | 0.660 |
| | critical asset are high. | |
| | Description (EconDisrupt) | |
| Low (L) | Some disruption is present and damage is equal to $$$. | 0.0 |
| Medium (M) | Significant time and resources are required and damage | 0.275 |
| | is equal to $$$$. | |
| High (H) | Operations are severely damaged, system survival is at | 0.660 |
| | risk and damage is equal to $$$$$-$$$$$$. | |

After the criticality impact metric values have been determined, calculate the score. The criticality impact score should be between 0 and 10. The criticality impact score is derived from the CVSS impact equation used to calculate the vulnerability score.

Second, calculate the magnitude of the criticality impact score. The VARM process 100 is to use the primary steps 1 (102), 2 (104) and 3 (106) to measure the magnitude of the impact. The impact is known from determining the criticality impact score. Impact score should range from 0 to 10. Impact is calculated with the following equation:

ImpactScore=10.41*(1−(1−Deaths)*(1−RepairProtec)*(1−EconDisrupt)) (1)

Note: The criticality impact score was adapted from the CVSS impact equation used to calculate the base score [6]. The criticality impact score can be utilized to help supplement in the evaluation and determination of critical assets. Steps 2 (104) and 3 (106) in the VARM process 100 will also determine values for threat and vulnerability impact that are incorporated into the threat and vulnerability score values. It is important to keep in mind that the impact analysis is done as a lateral step throughout the VARM process.

Step 2 (104) of the VARM process 100 (threat assessment) will now be described. A threat is any circumstance or event with the potential for a particular threat-source to successfully attack any exposed vulnerabilities. These vulnerabilities can be completed, whether as an accidental trigger or intentional exploit, causing an event with undesirable consequences or unfavorable impacts on organizational operations and assets, individuals, and other organizations.

The goal of threat identification is to identify all the potential threat-sources and compile a threat statement listing potential threat-sources that apply to the critical asset being evaluated. A threat-source is known to be an event where there is potential to cause harm to a power system. Threat-sources generally include: (i) hostile cyber/physical attacks; (ii) human errors of omission or commission; or (iii) natural and man-made disasters [4]. When identifying both cyber and physical threats for the critical asset, there are four categories to take into consideration; people, processes, physical environment and technology. FIG. 5 shows four areas of cyber/physical security categories: (1) people (e.g., inside, hacker/cracker, terrorists, social engineering, etc.); (2) processes (e.g., software development, purchasing, hiring, operation, etc.); (3) technology (e.g., hardware, firmware, communications/interfaces, security practices, etc.); and (4) physical environment (e.g., data centers, communication lines, internal/external, power, etc.).

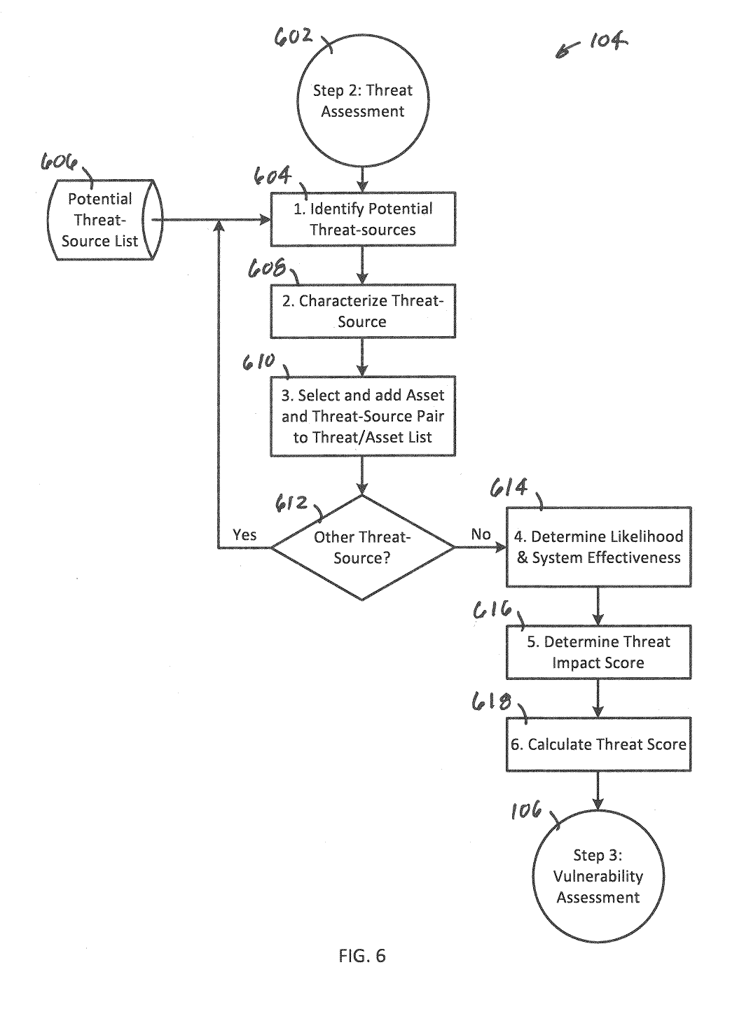

A flow chart is shown in FIG. 6 with step-by-step process to successfully accomplish the threat assessment 104 and obtain a threat score in order to proceed to the vulnerability assessment and complete the impact analysis in accordance with one embodiment of the present invention. The threat assessment process 104 begins in block 602. Potential threat-sources are identified in block 604 using a potential threat-source list 606. The threat-source source is characterized in block 608. An asset and threat-source pair are selected and added to the threat/asset list in block 610. If there are other threat-sources, as determined in decision block 612, the process loops back to identify potential threat-sources in block 604 and the process repeats as previously described. If, however, there are no other threat-sources, as determined in decision block 612, the likelihood and system effectiveness are determined in block 614. The threat impact score is determined in block 616 and the threat score is calculated in block 618. Thereafter, VARM process step 3 (106) vulnerability assessment is performed.

The goal of identifying all the threat-sources that are applicable to the critical assets in block 604 is to identify the potential threat-sources and compile a list repository listing all potential threat-sources applicable to the critical assets being evaluated. A threat-source is defined as any circumstance or event with the potential to harm a critical asset [4]. Threat-sources can be derived from a common threat-source list repository. A source list repository can be either provided by the customer with applicable threat-sources of the system being evaluated, or obtained and developed separately. Defining these sources is important being that these means can affect the outcome of an attack. Cyber/physical based attacks for critical infrastructures include: (1) protocol attacks; (2) denial of service (DoS); (3) worms/spyware/malware; (4) routing attacks; (5) intrusion attacks; (6) environmental attacks; (7) natural attacks; and (8) human attacks [adapted from [24]].

Protocol attacks are cyber-attacks that are not secured due to protocols used in power systems that can be exploited. When something like this occurs, secure versions of protocols must be developed immediately to provide security, latency and reliability guarantees needed for grid applications. Denial of Service (DoS) attacks are any attack that denies normal services to legitimate users. The power grid context refers to denial of service as denial of control as well. Worms/Spyware/Malware refers to malicious software that exploits vulnerabilities in system software, programmable logic controllers, or protocols. Routing attacks refer to cyber-attack on the routing infrastructure of the Internet. Although this attack is not directly related to the operation of the grid, a massive routing attack could have consequences on some of the power system applications, such as real-time markets, that rely on them. Intrusion attacks refers to exploiting vulnerabilities in the software and communication infrastructure of the grid which then provides access to critical system elements. Example intrusion scenario is to gain access to a substation human machine interface by passing security controls (firewalls, system passwords). Environmental attacks result from internal physical threats such as power failures or outages, chemical or nuclear attacks as well as water damage. Natural attacks result from external physical threats such as floods, earthquakes, hurricanes, and tornadoes. Human attacks occur when an insider abuses their current system privileges to perform a malicious action. This is done knowingly or unknowingly, in a counter-productive way to cause significant damage to his/her organization, and has become a key risk for organizations around the world.

The goal of characterizing the threat-source in block 608 is to characterize the threats into either cyber or physical threats. Table 2 presents a list of representative examples of cyber and physical threats to critical assets. These cyber physical threats are real and have a huge impact on the cost of power equipment costs and downtime, plus the cost of not doing business to the electric utility customer base.

TABLE 2
Representative examples of cyber and physical threats to power grids [1]

| Cyber Threats | Physical Threats | |
|---|---|---|
| Information Gathering | External/ | Severe Storms |
| Hactivism | Natural: | Tornados |
| Social Engineering | | Electrical/Magnetic Storms |
| Protocol Attack | | Earthquakes |
| Routing Attack | | Temperature Extremes |
| Denial of Service Attack | Internal/ | Power Failures |
| Malware/Adware/ | Environmental: | Chemical/Nuclear Attacks |
| Spyware Spam/Phishing | | Transportation Infrastructure |
| Weak Security Practices | | Fire (Electrical Origin) |
| | | Loss of Water |
| | | Electromagnetic Pulse |
| | Human: | Unintentional |
| | | Hacker/Cracker |
| | | Criminals |
| | | Terrorists |
| | | Industrial Espionage |
| | | Insiders |
| | | Social Engineering |

The goal of selecting and adding critical asset and threat-source pairs to the threat/asset pair list in block 610 is to begin pairing potential threat-sources to critical assets. Pairing threat sources and critical assets allow better mapping of specific threats to specific assets for creating specific scenarios. Only return to step one if there is another threat-source that needs to be paired with the critical asset. Otherwise, continue to determining the likelihood and system effectiveness.

The likelihood and system effectiveness determination in block 614 is a secondary step that will identify the input values for calculating the threat score. Quantitative values for both the likelihood and system effectiveness will be determined in this step of the VARM process. The likelihood rating indicates the probability that a potential critical asset will be subjected to an attack by the threat-source. In this step, each critical asset is analyzed to determine the factors that might make it a more or less attractive target to the threat-source. The system effectiveness rating indicates the level of any existing security countermeasures and/or controls that may be present in order to protect the critical asset. System effectiveness is determined by selecting the critical asset and potential threat-source pair, assigning a likelihood rating, and assigning a system effectiveness rating.

In the critical asset and potential threat-source pair selection step, each critical asset will be mapped to a potential threat-source or multiple threat-sources. It is important to keep in mind that a critical asset might have more than one threat-source that might carry out an attack. Assigning the likelihood rating will determine the probability or chance of the threat-source exercising an attack against a critical asset. First, evaluate the intent, motivation, and capability of a threat-source. Second, categorize the likelihood of the threat-source attacking the critical asset. Categories include almost certain, moderate and rare. Third, determine the probability of the critical asset being compromised using Table 3, which shows the categories and assigned values for determining the likelihood of a critical asset being compromised.

TABLE 3
Likelihood Determination Categories and Values

| Categories | Values |
|---|---|
| Almost Certain | 0.95 |
| Moderate | 0.55 |
| Rare | 0.25 |

Assigning the system effectiveness rating will determine the level of physical and cyber security controls currently in place for monitoring and protecting a critical asset. First, evaluate the existence and effectiveness of current security controls. Second, categorize the system security controls. Categories include direct monitoring, limited monitoring and no direct monitoring. Third, determine the value for system effectiveness by using Table 4. The following categories in Table 4 can be utilized for determining the system effectiveness rating.

TABLE 4
System Effectiveness Determination Categories and Values

| Categories | Value |
|---|---|
| Direct monitoring | 0.25 |
| Limited monitoring | 0.55 |
| No direct monitoring | 0.705 |

Equation 2 will be used to determine the likelihood and system effectiveness (LSE) score to be used for calculating the threat score.

LSE=15*Likelihood*SystemEffectiveness (2)

Note: The impact score was adapted from the CVSS exploitability equation used to calculate the base score [6].

The threat impact score is determined in block 616 in order to calculate the overall threat score. Threat impact score will consist of the evaluation of a set of metrics and determination of their corresponding quantitative values. The metrics being evaluated for identification of the threat impact score are the intent, motivation, and capability of a threat-source attacking a critical asset. The NIST SP 800-30 Revision 1 document was used as reference for determining metric descriptions shown in Table 5 for the intent, motivation, and capability [10].

TABLE 5
Threat Impact Score Evaluation Metrics

| Metric | Description (Intent) | Value |
|---|---|---|
| Low (L) | The threat-source seeks to disrupt the critical | 0.0 |
| | asset but is not concerned about attack detection. | |
| Medium (M) | The threat-source seeks to obtain or modify | 0.275 |
| | critical or sensitive information or disrupt | |
| | critical assets. Concerned about minimizing | |
| | attack detection | |
| High (H) | The threat-source seeks to undermine, severely | 0.660 |
| | impede, or destroy critical assets. Very concerned | |
| | on attack detection. | |
| Metric | Description (Motivation) | Value |
| Low (L) | The threat-source may or may not target any | 0.0 |
| | specific critical assets. | |
| Medium (M) | The threat-source analyses publicly available | 0.275 |
| | information to target any specific assets. | |
| High (H) | The threat-source analysis information obtained | 0.660 |
| | via reconnaissance to target specific critical | |
| | assets to attack. | |
| Metric | Description (Capability) | Value |
| Low (L) | The threat-source has limited resources, expertise, | 0.0 |
| | and opportunities to carry on the attack. | |
| Medium (M) | The threat-source has moderate resources, expertise, | 0.275 |
| | and opportunities to carry on the attack. | |
| High (H) | The threat-source has high level of expertise, well- | 0.660 |
| | resourced, and can generate opportunities to support | |
| | multiple successful, continues, and coordinated | |
| | attacks. | |

After the threat impact (T Impact) metric values have been determined, calculate the score by using the following equation. The threat impact score should be between 0 and 10.

TImpact=10.41*(1−(1−Intent)*(1−Motivation)*(1−Capability)) (3)

Note: The threat impact score was adapted from the CVSS impact equation used to calculate the base score [6].

A threat score is calculated in block 618 for the threat-source and critical asset pair. The calculation is divided into two sections: the likelihood of an attack and the system effectiveness and threat impact. Therefore, the previously calculated values in Step 4 for likelihood and system effectiveness will be used to calculate the threat score. Incorporating different methodologies in the VARM process is guided by Equation 4 for calculating a quantitative value for threat (adapted from CVSS):

ThreatScore=round_to_{—}1_decimal(((0.6*TImpact)+(0.4*LSE)−1.5)*f(Impact))

TImpact=10.41*(1−(1−Intent)*(1−Motivation)*(1−Capability))

LSE=15*Likelihood*SystemEffectiveness (4)

f(Impact)=0 if TImpact=0, 1.176 otherwise
Note: The threat score was adapted from the CVSS base equation used to calculate the base score [6]. The probability of an attack associates both the consequences and efforts taken in regards to a threat. System effectiveness incorporates attack capability and asset security regarding a threat.

Step 3 (106) of the VARM process 100 (vulnerability assessment) includes the relative pairing of each critical asset and threat to identify potential vulnerabilities related to the critical asset. This involves the identification of existing countermeasures (as per Step 1) and their level of effectiveness in reducing those vulnerabilities. The degree of vulnerability of each valued asset and threat pairing is evaluated by the formulation of risk scenarios. The goal of this step is to develop a list of critical asset vulnerabilities that could be exploited by the potential threat-sources.

Using the NISTIR 7826 Vols. 1-3 document as a guide, a vulnerability class is used to categorize weaknesses which could adversely impact the operational technology of an energy system [11]. Below are the five specific areas which can make an energy system vulnerable as well as the possible impacts of vulnerabilities if they were to be put into effect: (1) policy and procedure; (2) people; (3) platform software/firmware vulnerabilities; (4) platform vulnerabilities; and (5) network vulnerabilities. Referencing back to the NISTIR 7826 documents can provide more of a definition of each class and with more examples of impacts [11].

Policies and procedures are known to be documented methods on how the infrastructure operates. Vulnerabilities can include insufficient procedures on validation and background checks, inadequate security policies, privacy policies, patch management processes, and change and configuration management to the system. The risk management process is part of this class and is to have a well-documented defense system for potential vulnerabilities.

In regards to people, they are to be the ones trained to follow the policy and procedures developed for the electrical power grid. This category covers vulnerabilities on personnel security awareness training associated with implementing, maintaining and operating systems. Some examples include: (a) employee information; (b) password posting; and (c) poor security notification of inappropriate or suspicious use of network cables or devices.

Software and firmware design, development and deployment can have vulnerabilities and of course, result in attacks. Software and firmware development include vulnerabilities in code quality, authentication, cryptography, general logic errors and password management. Common Vulnerability and Exposures (CVE) specification are used to establish a common identifier for vulnerability as well as some other descriptions from the Common Weakness Enumeration (CWE) and vulnerability categories defined by the Open Web Application Security Project (OWASP).

Platform vulnerabilities regard software or hardware units that are compromised in areas of security architecture and design, inadequate malware protection from software attacks and software vulnerabilities. These vulnerabilities include categories of designs, implementation, and operational and poorly configured security equipment. Some examples include: (a) inadequate security architectures and designs by untrained engineers; (b) lack of understating due to poor peer reviews for security designs; and (c) inadequate malware protection.

Areas for network vulnerabilities are data integrity, security, protocol encryption, authentication and device hardware. Some examples include: (a) lack of integrity checking of communication; (b) ineffective network security architectures; (c) physical access to a device; and (d) weaknesses in authentication process or authentication keys.

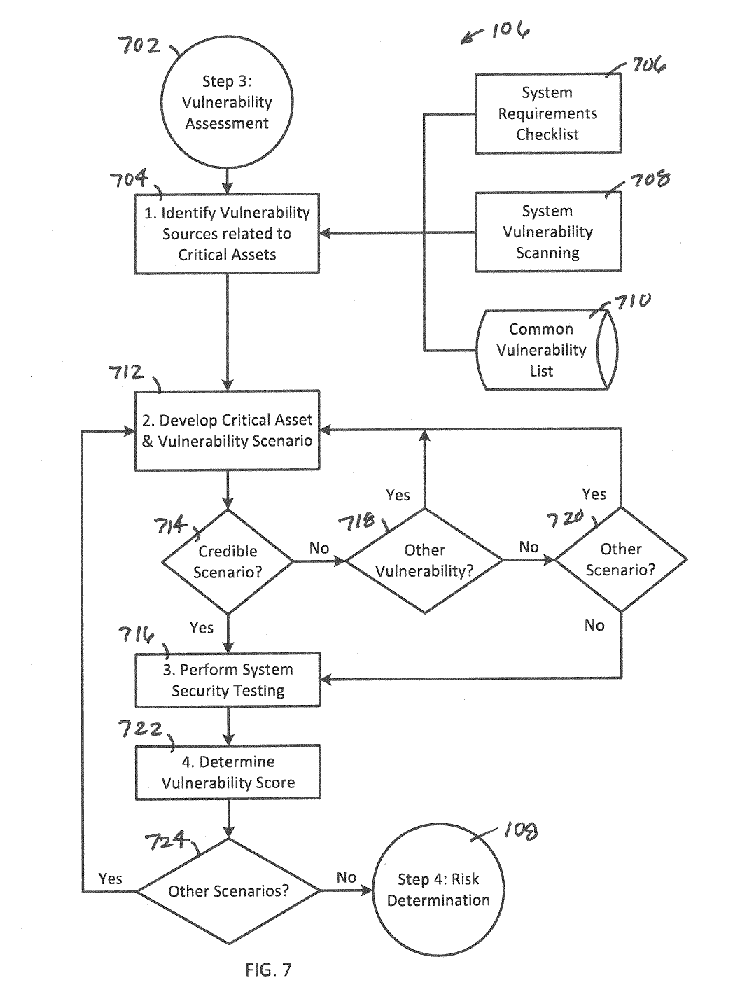

FIG. 7 is a flow chart showing a step-by-step process to successfully accomplish the vulnerability assessment 106 in order to proceed to the risk determination 108 in accordance with one embodiment of the present invention. The vulnerability assessment process 106 begins in block 702. Vulnerability sources related to critical assets are identified in block 704 using a system requirement checklist 706, system vulnerability scanning 708, and/or common vulnerability list 710. A critical asset and vulnerability scenario is developed in block 712. If the scenario is credible, as determined in decision block 714, system security testing is performed in block 716. If, however, the scenario is not credible, as determined in decision block 714, and there are other vulnerabilities, as determined in decision block 718, the process returns to develop a critical asset and vulnerability scenario in block 712. If, however, there are no other vulnerabilities, as determined in decision block 718, and there are other scenarios, as determined in decision block 720, the process returns to develop a critical asset and vulnerability scenario in block 712. If, however, there are no other scenarios, as determined in decision block 720, system security testing is performed in block 716. After the system security testing in block 716, a vulnerability score is determined in block 722. If there are other scenarios, as determined in decision block 724, the process returns to develop a critical asset and vulnerability scenario in block 712. If, however, there are no other scenarios, as determined in decision block 724, VARM process step 4 (108) risk determination is performed.

The identification of vulnerability sources in block 704 may be performed by using any or all of the following processes: system requirement checklist 706, system vulnerability scanning 708, and/or common vulnerability list 710. Develop a system requirements checklist 706 to manually and systematically evaluate and identify the vulnerabilities of the assets (personnel, hardware, software, information), non-automated procedures, processes, and information transfers associated with a given power grid in the following security areas [4]: management; operational; and technical. In the management security area, security criteria may include assignment of responsibilities, incident response capability, security control review, system or application security plan, etc. In the operational security area, security criteria may include controls to ensure quality of electricity, data media access and disposal, facility protection, etc. In the technical security area, security criteria may include communications (e.g., dial-in, system interconnection, routers), cryptography, intrusion detection, identification and authentication, etc. The Guide for Assessing the High-Level Security Requirements in NISTIR 7628 provides a set of guidelines for building effective security assessment plans and a baseline set of procedures for assessing the security requirements needed for Smart Grid information systems [21].

System vulnerability scanning 708 can be automated in order to scan a group of hosts or a network for known vulnerabilities. Note: Some of the potential vulnerabilities identified might not represent real vulnerabilities and therefore produce false positives.

Obtain vulnerabilities from a common vulnerability list or database 710 available through online services provided by international and national organizations. The Open Web Application Security Project (OWASP) is one such service. The National Vulnerability Database (NVD) provides details for publicly known vulnerabilities. Common Vulnerabilities and Exposures (CVE) provides framework that identifies and classifies vulnerabilities according to the causes “as they are manifested in code, design, or architecture” [6]. The United States Computer Emergency Readiness Team (US-CERT) provides vulnerability and threat information through its National Cyber Awareness System (NCAS), and operates a Vulnerability Notes Database to provide technical descriptions of system vulnerabilities [9].

In characterizing the vulnerability in block 712, each asset in the Critical Asset List from Step 1 is reviewed in conjunction with the threat assessment from Step 2 to identify the vulnerabilities. Vulnerabilities need to be classified as cyber or physical in this step of the VARM process.

With respect to performing system security testing to further identify system vulnerabilities in block 716, employing system security testing can further identify vulnerabilities and help into scoring the vulnerabilities as done in step 4. Testing methods include: automated vulnerability scanning; security test and evaluation; and penetration testing.

With respect to automated vulnerability scanning, tools developed to discover how secure or how resistant to attack. Normally searching for what a device has operational, anti-virus and intrusion detection/protection systems being examples. These scanners check the configuration and system settings to report back on how vulnerable a target is. Existing vulnerability analysis tools are classified into six types of scanners as seen on Table 6 [19].

TABLE 6
Vulnerability Scanning Tools [19]

| | |
|---|---|
| Network | IBM Proventia Network Enterprise Scanner, eEye |
| Scanners | Retina Network, McAfee Vulnerability Manager, etc. |
| Host Scanners | Microsoft Attack Surface Analyzer, Threat Guard |
| | Secutor, Assuria Auditor, etc. |
| Database | McAfee Repscan and Vulnerability Manager for |
| Scanners | Databases, Imperva Scuba, etc. |
| Web Application | IBM/Rational AppScan, Grabber, eEye Retina Web, |
| Scanners | HP Webinspect, etc. |
| Multilevel | Semantic Risk Automation Suite, Tenable Nessus |
| Scanners | 4.4, Jump Network Jabil Network Vulnerability |
| | Assessment System, etc. |
| Vulnerability | Assurance Application 3.0, Epok CAULDRON, Red |
| Scan | Seal Vulnerability Advisor 4.2, etc. |
| Consolidators | |

With respect to security test and evaluation, cyber physical systems for ICS (Industrial Control Systems)/SCADA (supervisory control and data acquisition) must be evaluated and tested for possible air-gaps (a physical gap between the control network and the business network), lack of security policies, faulty architectures, poor or nonexistent contingency plans, poor staff training, deficient cyber security culture and ethics. Multiple certified methods and analysis assist to rate the deficiencies on the security of the client critical infrastructures. The key resources to analyze are the legacy systems, possible treat prevention, knowing that there is consciousness of the threat, type of operating systems and updates, what security tools are used and can be implemented, the cost of storage and how data is been manage, connections to the Internet and cryptographic methods been used or to be used for protection of critical data.

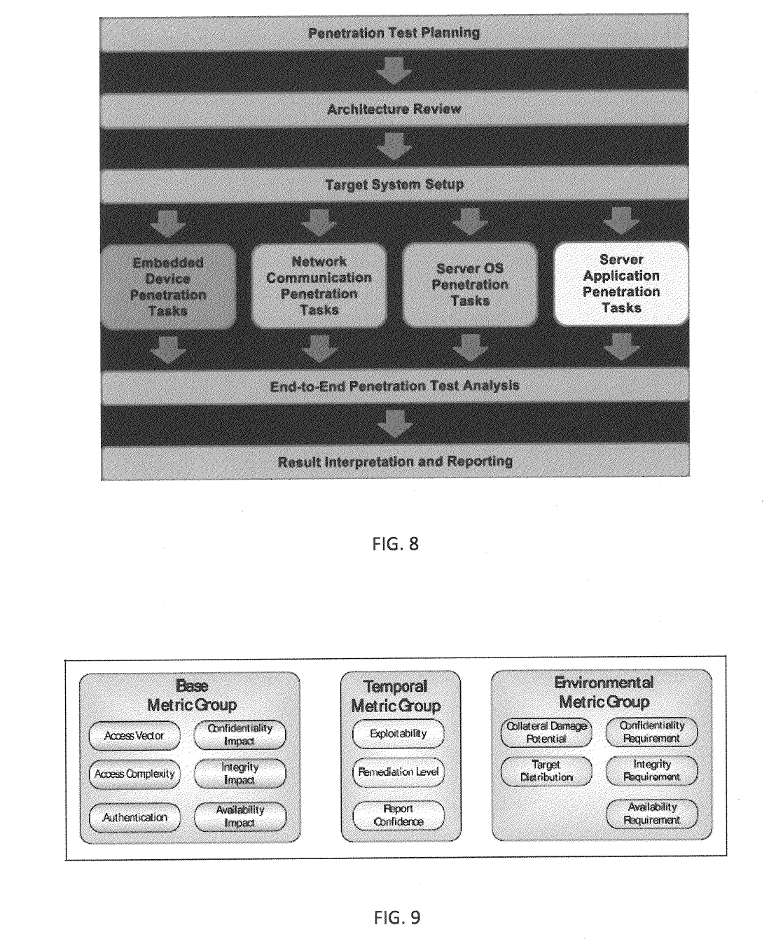

With respect to penetration testing, experts in gaining access to systems take the vulnerability report from the target and attempt to gain access to the target. Penetration testing follows a four-step methodology of finger print, exploit, backdoor, and report. These steps are sequential. Finger printing identifies the services, operating system, and port configuration of the device. Exploitation takes the information gathered in the previous steps to tailor a set of attacks that attempt to gain access to the remote system. The backdoor step determines if an attacker can maintain access to the system without being noticed. The final stage reporting compiles the information gathered from all three steps into a human understandable format. FIG. 8 shows the overall process flow of a typical penetration test as described by the National Electric Sector Cybersecurity Organization Resource (NESCOR) [20]. Existing penetration testing tools are shown in Table 7.

TABLE 7
Penetration Testing Tools [19]

| Tools | Examples |
|---|---|
| Automated | Rapid 7 Metasploit and NeXpose, Google Skipfish, |
| Penetration | Core Impact and Insight, Immunity Canvas, Spirent |
| Test Tools | Avalanche Vulnerability Assessment, etc. |

With respect to determining the vulnerability score in block 722, the Common Vulnerability Scoring System (CVSS) provides an open framework for communicating the characteristics and impacts of IT vulnerabilities. The CVSS is made up of three main metric groups and each consisting with a set of metrics for calculating the vulnerability score as seen in FIG. 9. It is not required to evaluate all three metric groups. Optionally, the base score can be refined by assigning values to the temporal and environmental metrics. Depending on the type of assessment required, the base score calculation and vector may be sufficient [6]. The vulnerability score will range from 0 to 10.

First, values for the base metric group are identified. This metric group will capture the characteristics of vulnerabilities that are constant with time and across user environments [6]. Metric values and descriptions are provided as follows and must be determined by the vulnerability assessment security expert. For further explanation on metrics refer to the CVSS document provided by NIST.

TABLE 8
Access Vector Scoring Evaluation [6]

| Metric | | |
|---|---|---|
| Value | Description (AccessVector) | Value |
| Local | A vulnerability exploitable with only local access | 0.395 |
| (L) | requires the attacker to have either physical | |
| | access to the vulnerable system or a local (shell) | |
| | account. Examples of locally exploitable vulnera- | |
| | bilities are peripheral attacks such as Firewire/ | |
| | USB DMA attacks, and local privilege escalations | |
| | (e.g., sudo). | |
| Adjacent | A vulnerability exploitable with adjacent network | 0.646 |
| Network | access requires the attacker to have access to | |
| (A) | either the broadcast or collision domain of the | |
| | vulnerable software. Examples of local networks | |
| | include local IP subnet, Bluetooth, IEEE 802.11, | |
| | and local Ethernet segment. | |
| Network | A vulnerability exploitable with network access | 1.0 |
| (N) | means the vulnerable software is bound to the | |
| | network stack and the attacker does not require | |
| | local network access or local access. Such a | |
| | vulnerability is often termed “remotely | |
| | exploitable”. An example of a network attack | |
| | is a RPC buffer overflow. | |

TABLE 9
Access Complexity Scoring Evaluation [6]

| Metric | | |
|---|---|---|
| Value | Description (AccessComplexity) | Value |
| High | Specialized access conditions exist. For example: | 0.35 |
| (H) | In most configurations, the attacking party must already | |
| | have elevated privileges or spoof additional systems in | |
| | addition to the attacking system (e.g., DNS hijacking). | |
| | The attack depends on social engineering methods that | |
| | would be easily detected by knowledgeable people. For | |
| | example, the victim must perform several suspicious or | |
| | atypical actions. | |
| | The vulnerable configuration is seen vary rarely in | |
| | practice. | |
| | If a race condition exists, the window is very narrow. | |
| Medium | The access conditions are somewhat specialized; the | 0.61 |
| (M) | following are examples: | |
| | The attacking party is limited to a group of systems | |
| | or users at some level of authorization, possibly | |
| | untrusted. | |
| | Some information must be gathered before a successful | |
| | attack can be launched. | |
| | The affected configuration is non-default, and is not | |
| | commonly configured (e.g., a vulnerability present | |
| | when a server performs user account authentication | |
| | via a specific scheme, but not present for another | |
| | authentication scheme). | |
| | The attack requires a small amount of social engineering | |
| | that might occasionally fool cautious users (e.g., | |
| | phishing attacks that modify a web browser's status bar | |
| | to show a false link, having to be on someone's | |
| | “buddy” list before sending an IM exploit). | |
| Low | Specialized access conditions or extenuation | 0.71 |
| (L) | circumstances do not exist. The following are examples: | |
| | The affected product typically requires access to a wide | |
| | range of systems and users, possibly anonymous and | |
| | untrusted (e.g., Internet-facing web or mail server). | |
| | The affected configuration is default or ubiquitous. | |
| | The attack can be performed manually and requires little | |
| | skill or additional information gathering. | |
| | The “race condition” is a lazy one (i.e., it is | |
| | technically a race but easily winnable). | |

TABLE 10
Authentication Scoring Evaluation [6]

| Metric | | |
|---|---|---|
| Value | Description (Authentication) | Value |
| Multiple | Exploiting the vulnerability requires that the | 0.45 |
| (M) | attacker authenticate two or more times, even | |
| | if the same credentials are used each time. | |
| | An example is an attacker authentication to an | |
| | operating system in addition to providing | |
| | credentials to access an application hosted on | |
| | that system. | |
| Single | One instance of authentication is required to | 0.56 |
| (S) | access and exploit the vulnerability. | |
| None | Authentication is not required to access and | 0.704 |
| (N) | exploit the vulnerability. | |

TABLE 11
Confidentiality Impact Scoring Evaluation [6]

| Metric Value | Description (ConfImpact) | Value |
|---|---|---|
| None (N) | There is no impact to the confidentiality of | 0.0 |
| | the system. | |
| Partial (P) | There is considerable informational disclosure. | 0.275 |
| | Access to some system files is possible, but the | |
| | attacker does not have control over what is | |
| | obtained, or the scope of the loss is constrained. | |
| | An example is a vulnerability that divulges only | |
| | certain tables in a database. | |
| Complete (C) | There is total information disclosure, resulting | 0.660 |
| | in all system files being revealed. The attacker | |
| | is able to read all of the system's data | |
| | (memory, files, etc.). | |

TABLE 12
Integrity Impact Scoring Evaluation [6]

| Metric Value | Description (IntegImpact) | Value |
|---|---|---|
| None (N) | There is no impact to the integrity of the system. | 0.0 |
| Partial | Modification of some system files or information | 0.275 |
| (P) | is possible, but the attacker does not have control | |
| | over what can be modified, or the scope of what the | |
| | attacker can affect is limited. For example is, | |
| | system or application files may be overwritten or | |
| | modified, but either the attacker has no control | |
| | over which files are affected or the attacker can | |
| | modify files within only a limited context or scope. | |
| Complete | There is a total compromise of system integrity. | 0.660 |
| (C) | There is a complete loss of system protection, | |
| | resulting in the entire system being compromised. | |
| | The attacker is able to modify any files on the | |
| | targeted system. | |

TABLE 13
Availability Impact Scoring Evaluation [6]

| Metric | | |
|---|---|---|
| Value | Description (AvailImpact) | Value |
| None | There is no impact to the availability of the | 0.0 |
| (N) | system. | |
| Partial | There is reduced performance or interruptions in | 0.275 |
| (P) | resource availability. An example is a network- | |
| | based flood attack that permits a limited number | |
| | of successful connections to an Internet service. | |
| Complete | There is a total shutdown of the affected resource. | 0.660 |
| (C) | The attacker can render the resource completely | |
| | unavailable. | |

Second, the vulnerability score is calculated by using the base equation. The base equation is derived from the CVSS standard. Equation 5 below is used for calculating the vulnerability score:

VulnerabilityScore=round_to_{—}1_decimal(((0.6*VImpact)+(0.4*Exploitability)−0.5)*f(Impact))

VImpact=10.41*(1−(1−ConfImpact)*(1−IntegImpact)*(1−AvailImpact))

Exploitability=20*AccessVector*AccessComplexity*Authentication

f(Impact)=0 if VImpact=0, 1.176 otherwise

The last primary step, Step 4 (108) of the VARM process 100 (risk determination), is the calculation of the risk of a critical asset being compromised by a threat-source. In most references, risk is calculated as a function of threat, vulnerability, and impact. The magnitude of the risk is directly dependent on the value for the obtained impact, threat, and vulnerability score. Therefore, the increase or decrease in the value for the impact, threat, or vulnerability will directly affect the magnitude of the risk from cyber and physical attacks.

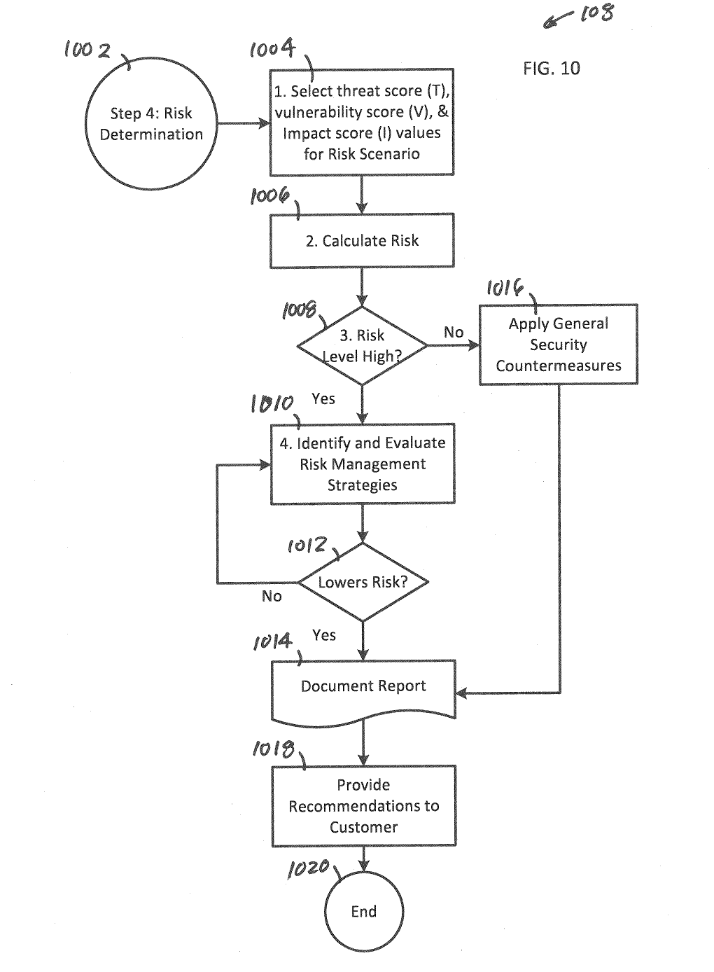

FIG. 10 shows a flow chart with a step-by-step process to successfully accomplish the risk determination 108 in accordance with one embodiment of the present invention. Step 4 (108) of the VARM process 100 (risk determination) begins in block 1002. The threat score (T), vulnerability score (V) and impact score (I) values are selected for the risk scenario in block 1004, and the risk is calculated in block 1006. If the risk level is high, as determined in decision block 1108, risk management strategies are identified and evaluated in block 1010. If the identified risk management strategy lowers risk, as determined in decision bock 1012, a report document is prepared in block 1014. If, however, the identified risk management strategy does not lower risk, as determined in decision block 1012, another risk management strategy is identified and evaluated in block 1010 and the process continues as previously described. If, however, the risk level is not high, as determined in decision block 1008, general security countermeasures are applied in block 1016 and the report document is prepared in block 1014. Thereafter, recommendations are provided to the customer in block 1018 and the VARM process ends in block 1020.

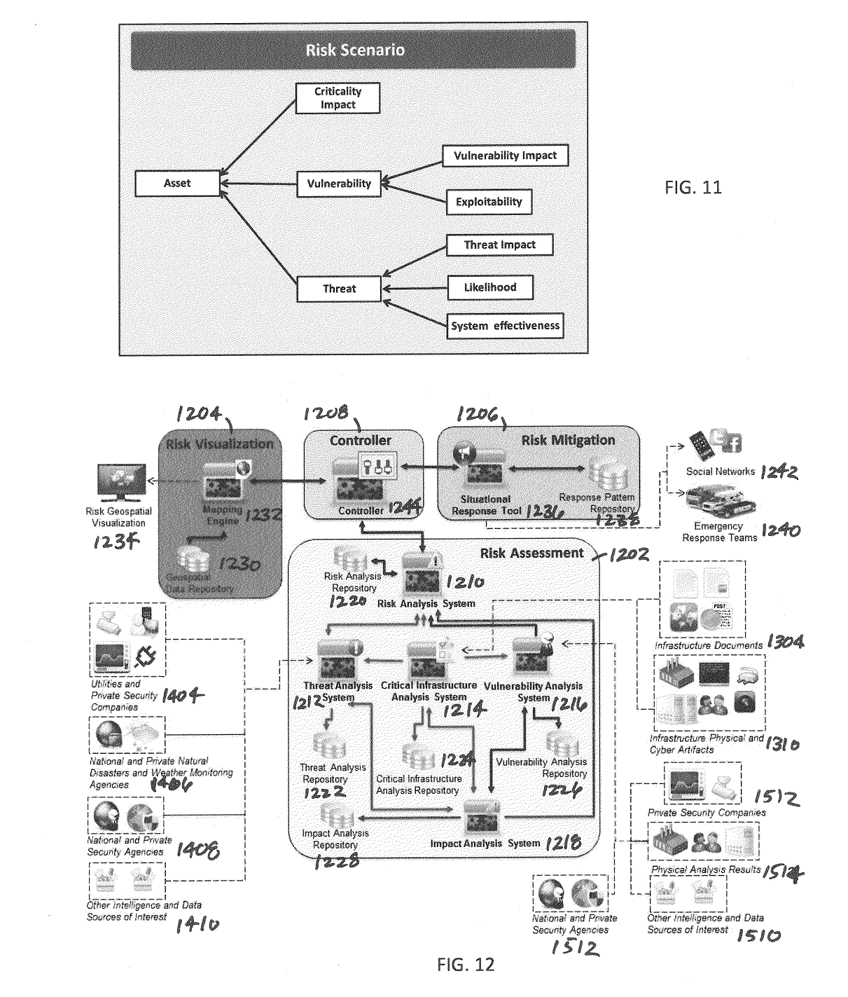

With respect to identifying the risk scenario with threat, vulnerability, and impact scores in block 1004, these values are obtained from the primary steps 1 through 3. A risk scenario includes a critical asset with the assigned threat and vulnerability score. FIG. 11 shows the development of how a risk scenario is formed throughout the VARM process.

With respect to calculating the magnitude of the risk in block 1006, in most references, risk is calculated as a function of threat, vulnerability, and impact. For example, methodologies developed by Sandia National Laboratories to successfully calculate the expected loss from attacks, known as risk assessment methodologies (RAMs), were used as a guide. The following equation was developed to assess the risk for a critical asset with multiple threats and vulnerabilities. The risk function is expressed as a summation of weighted variables as shown in Equation 6.

Risk(R)=Σf(x,a)=Σᵢ₌₁^{∞}(aᵢ*xᵢ) (6)
aᵢ=weight of importance
xᵢ=T, V, I
   Where xᵢ are the variables threat (T), vulnerability (V), impact (I) and aᵢ are weighted values that are chosen based on the risk scenario being evaluated. The values for threat, vulnerability, and impact have to be calculated separately; however they are inter-related in reality. The unit for risk is unit-less, even though the impact value can be expressed as cost in $. Multiple risk scenarios can be created for one critical asset. Therefore, it will be necessary to assign weights to prioritize the variables accordingly.

With respect to determining if the risk level is high in decision block 1008, the magnitude of the risk is evaluated to determine if the risk is high on a critical asset. This consists of the consolidation of multiple risks on a critical asset. If risk is high, then proceed to next step for identifying and evaluating security countermeasures to mitigate risk. General security countermeasures are applied to critical assets with a low risk.

With respect to identifying and evaluating strategies, treatments, or security countermeasures in order reduce or eliminate risk in block 1010, strategies, treatments, or countermeasures that could mitigate or eliminate the identified risks are provided. Risks can be managed by one of four distinct methods: Risk acceptance, Risk avoidance, Risk control, Risk transfer [14]. These Risk Management Strategies are defined as follows:
Risk Acceptance: An explicit or implicit decision not to take an action that would affect a particular risk.
Risk Avoidance: A strategy or measure which effectively removes the exposure of an organization to a risk.
Risk Control (or reduction): Deliberate actions taken to reduce a risk's potential for harm or maintain the risk at an acceptable level.
Risk Transfer (or deflection): Shifting some or all of the risk to another entity, asset, system, network, or geographic area.
   After determining the type of risk management strategy to apply, the following factors should be recommended for minimizing or eliminating the risk but should not be limited to these [4]: (a) effectiveness of recommended solutions (e.g. system compatibility); (b) legislation and regulation; (c) organizational policy; (d) operational impact; and (e) safety and reliability.

The risk management strategies identified in this step should serve the purpose for recommending possible solutions for the customer to mitigate their risks. It should be noted that not all possible solutions can be implemented to eliminate loss due to a security breach event. To determine which ones are required for a specific system, a cost-benefit analysis should be conducted to evaluate the proposed security countermeasures.

Recommend to the customer solution sets that mitigate or eliminate the risk for the customer's OT energy system. The recommendations can be put together using the customer's hardware, software, services, and products as solutions to mitigate or eliminate the risks. The proposed solutions may include budget estimates, equipment lists, integration services, installation and testing, and maintenance plans. For example, adding a cyber security appliance to a distribution substation that protects the substation IP address from cyber based attacks. The appliance may be a combination of a firewall and intrusion detection system. Other solutions for the customer to secure their system are as follows [13]: (a) threat modeling; (b) segmentation; (c) code and command signing; (d) honeypots; (e) encryption; (f) vulnerability management; (g) source code review; (h) configuration hardening; (i) strong authentication; and/or (j) logging and monitoring.

The documentation provided to the customer presents the results in a format so they can understand their risks (vulnerabilities, risk points, gaps, etc.). The VARM results may include a written report that documents: (a) the scope and objectives of the assessment; (b) the VARM team members, roles, experience, and expertise; (c) the critical assets identified and their impacts; (d) the threats and security vulnerabilities of the electrical power grid; (e) a set of recommendations to reduce risk; (f) schedule and milestones for solutions; (g) preliminary costs for solutions; and/or (h) audit trail of VARM activities.

The VARM process 100 described above can be supported by the software architecture 1200 depicted in FIG. 12. The software architecture is composed of four major systems (represented in the figure as rounded-rectangles), each of which has a specific function. The risk assessment system 1202 calculates the risk associated with the different critical assets on an infrastructure. The risk visualization system 1204 is used to geospatially visualize the results of the risk assessment process over the infrastructure. An extension to the VARM is the ability to alert interested parties whenever the risk is high for a set of critical assets. The software architecture supports situational response to high-risk scenarios by providing a risk mitigation system 1206 which distributes emergency response protocols to emergency response teams and the general public, if necessary. Finally, the controller system 1208 acts as a control manager for the interaction between the VARM's major systems. Every system is composed of one or more modules that interact with each other to accomplish the system goal. The specific descriptions are provided below.

The risk assessment subsystem 1202 is composed of five major subsystems (risk analysis system 1210, threat analysis system 1212, critical infrastructure analysis system 1214, vulnerability analysis system 1216, and impact analysis system 1218) and five data repositories (risk analysis repository 1220, threat analysis repository 1222, critical infrastructure analysis repository 1224, vulnerability analysis repository 1226, and impact analysis repository 1228). The descriptions and functionalities of the subsystems and data repositories are described below.

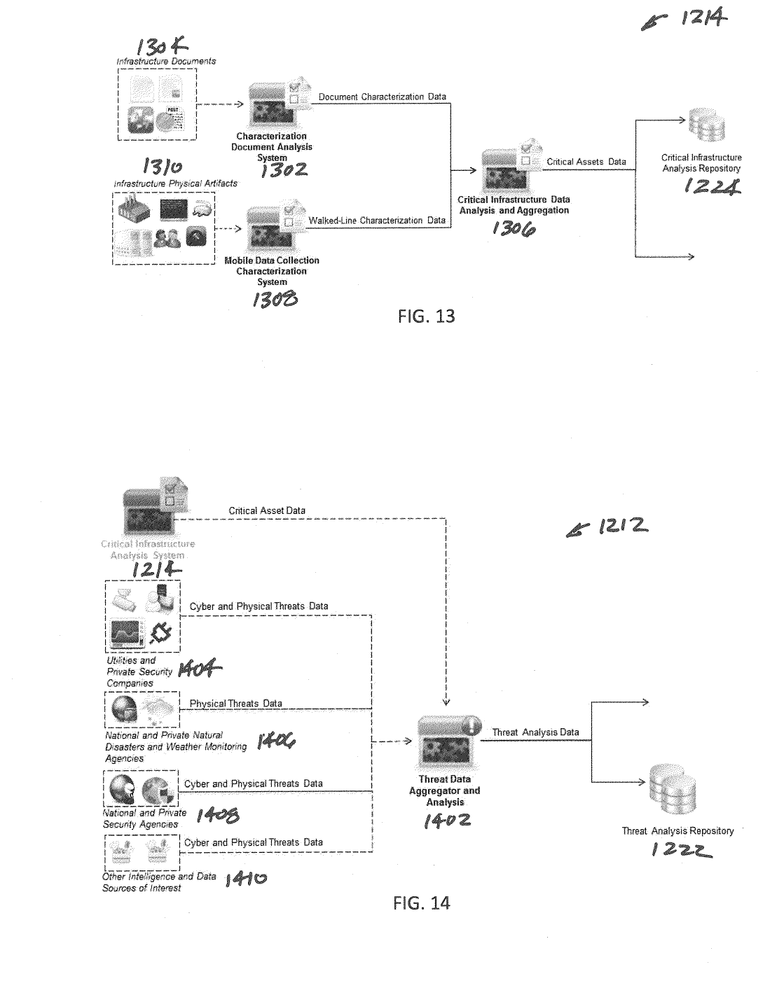

The software support for the critical infrastructure process 102 in accordance with one embodiment of the present invention is shown in FIG. 13. The critical infrastructure analysis subsystem 1214 allows users to identify IT and OT critical assets on an infrastructure. The critical infrastructure analysis subsystem 1214 is composed of three modules.

The characterization document analysis system 1302 allows users to analyze infrastructure documents 1304 of different formats, digitally mark the documents on regions of interest, associate infrastructure metadata for the selected region of interest, and determine criticality of the asset. To determine the criticality of an asset, the characterization document analysis system 1302 guides the user through a series of questions, based on the initial impact analysis step of the VARM process, an automatically calculate a criticality level for the asset. Once the process is completed, the critical infrastructure analysis results are used as input to the critical infrastructure data analysis and aggregation system 1306.

The mobile data collection characterization system 1308 allows users to capture metadata 1310 and analyze critical levels for physical assets as they are discovered by an operator conducting physical inspections. The mobile application system 1304 allows operators to capture metadata 1310 such as geospatial location and graphical representation of the physical assets in addition to other general information. To determine the criticality of an asset, the mobile data collection characterization system 1304 guides the user through a series of questions, based on the initial impact analysis step of the VARM process, an automatically calculate a criticality level for the asset. Once the process is completed, the critical infrastructure analysis results are used as input to the critical infrastructure data analysis and aggregation system 1306.

The critical infrastructure data analysis and aggregation system 1306 aggregates the results obtained by the characterization document analysis 1302 and mobile data collection characterization system 1308 into a single data collection. The data collection is analyzed to determine further critical infrastructure assets. The data collection is then stored on a critical infrastructure analysis repository 1224 along with the marked documents.

The software support for the threat analysis process 104 in accordance with one embodiment of the present invention is shown in FIG. 14. The threat analysis subsystem 1212 allows users to identify current and past threats, for both the IT and the OT domains, associated with the critical infrastructure assets identified by the critical infrastructure analysis subsystem 1214. The main system in the threat analysis subsystem 1212 is the threat data aggregator and analysis system 1402. The threat data aggregator and analysis system 1402 uses information from different sources to identify threats to critical assets and to determine the likelihood of an attack at near-real time. Some examples of sources from which threat data can be obtained include utilities and private security companies 1404, national and private natural disasters and weather monitoring agencies 1406, and national security agencies 1408. The threat data aggregator and analysis system 1402 can be extended to include other data sources of interest 1410 and is not limited to the ones previously listed. The threat data aggregator and analysis system 1402 analyzes the data and cross-references the analysis results with the critical infrastructure assets to determine the likelihood of an attack for every asset. The results of the threat analysis are stored in a threat analysis repository 1222.

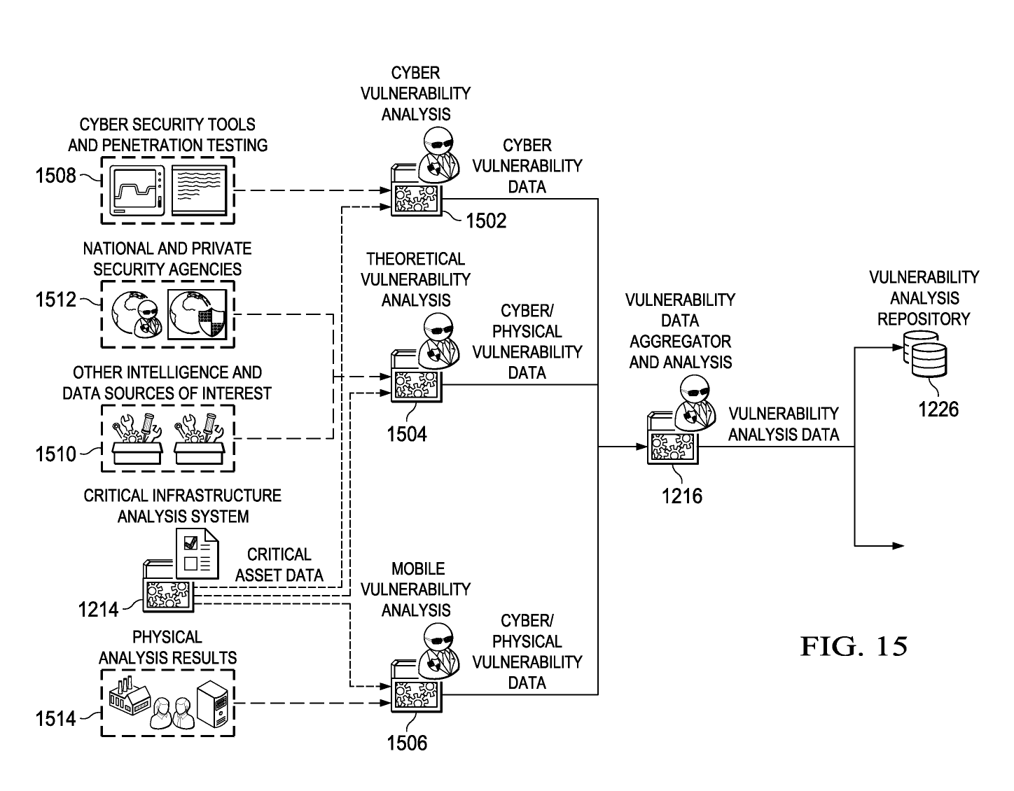

The software support for the vulnerability assessment process 106 in accordance with one embodiment of the present invention is shown in FIG. 15. The vulnerability analysis system 1216 is used to identify IT and OT vulnerabilities on critical assets. The vulnerability analysis module 1216 uses the result from IT vulnerabilities scans and information from national and international vulnerabilities databases to create vulnerability profiles for the critical assets. The vulnerability profiles include the list of information technology and operational technology components associated with a critical asset as well as the vulnerabilities associated with each vulnerable asset. The results of the vulnerability analysis are stored in a data repository. The vulnerability analysis system 1216 is composed of three systems: a cyber vulnerability system 1502, a theoretical vulnerability system 1504, and a mobile vulnerability system 1506.

The cyber vulnerability system 1502 aggregates and analyzes the results from cyber security tools and penetration testing 1508 used to evaluate the cyber vulnerabilities of a system. The cyber vulnerability system 1502 identifies vulnerability patterns by cross-referencing the results of the cyber security tools and the penetration testing 1508. The theoretical vulnerability system 1504 is used to aggregate and analyze subjective vulnerabilities associated with critical assets based on vulnerability data repositories 1510 and input from security agencies 1512. The mobile vulnerability analysis system 1506 allows operators to physically inspect an asset and document vulnerabilities 1514 as they are discovered as part of the inspection process.

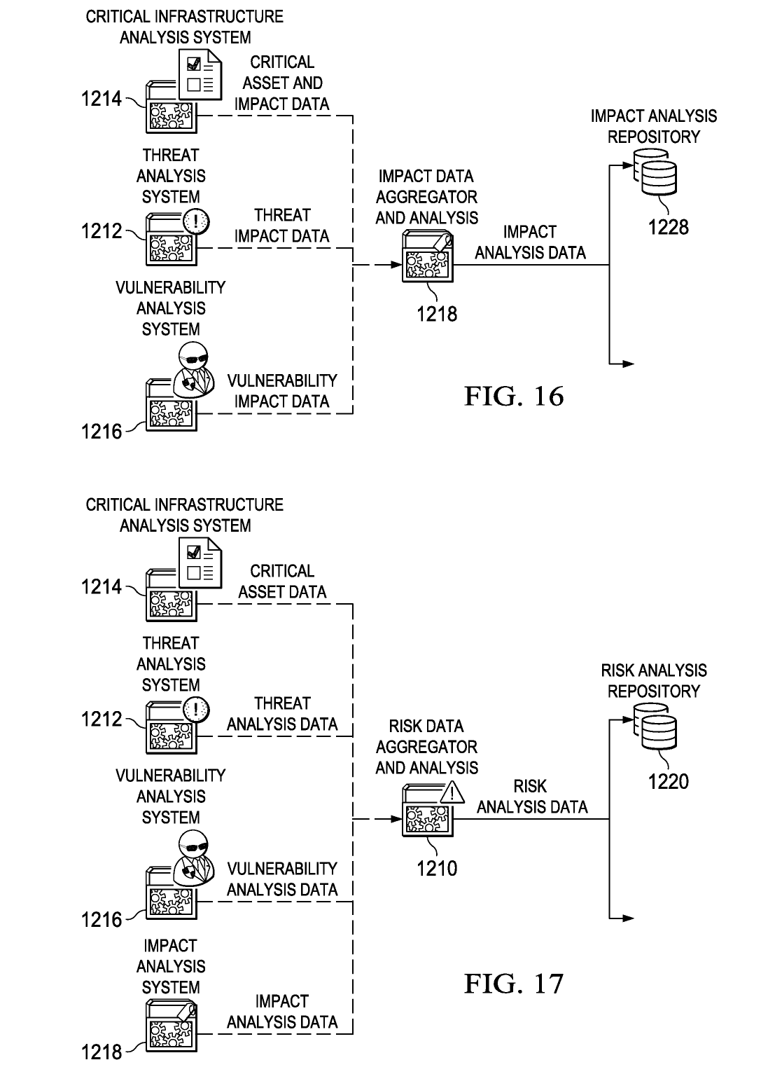

The software support for the impact analysis process 110 in accordance with one embodiment of the present invention is shown in FIG. 16. The impact analysis system 1218 is used to aggregate the baseline 1214, threat impact 1212 and vulnerability impact 1216 analysis results. The impact data analysis module 1218 is also used to determine impact propagation through an infrastructure and the results are used to re-evaluate critical assets. The impact analysis system 1218 provides as a real-time mechanism that re-evaluates the infrastructure to identify new assets that require VARM evaluations. The results of the impact analysis are stored on an impact analysis repository 1228.

The software support for the risk determination process 108 in accordance with one embodiment of the present invention is shown in FIG. 17. The risk analysis system 1210 aggregates the results from the critical infrastructure 1214, threat 1212, vulnerability 1216, and impact analysis 1218 systems and calculates a risk value for every asset used by the other systems. The risk analysis system 1210 can be used with data retrieved from repositories or with real-time data. The results of the risk analysis are stored on a risk analysis repository 1220.

Now referring back to FIG. 12, the risk visualization subsystem 1204 is composed of two components, a geospatial data repository 1230 and a mapping engine module 1232. The geospatial data repository 1230 contains geospatial data obtained from national agencies and private companies that can be used to graphically locate in a map places of interest. The mapping engine module 1232 takes as input geospatial data from the geospatial data repository 1230 and the results from the risk analysis and creates a geospatial graphical representation 1234 of the critical assets on a map as well as near real-time feeds of risk, threat, vulnerability, and impact.

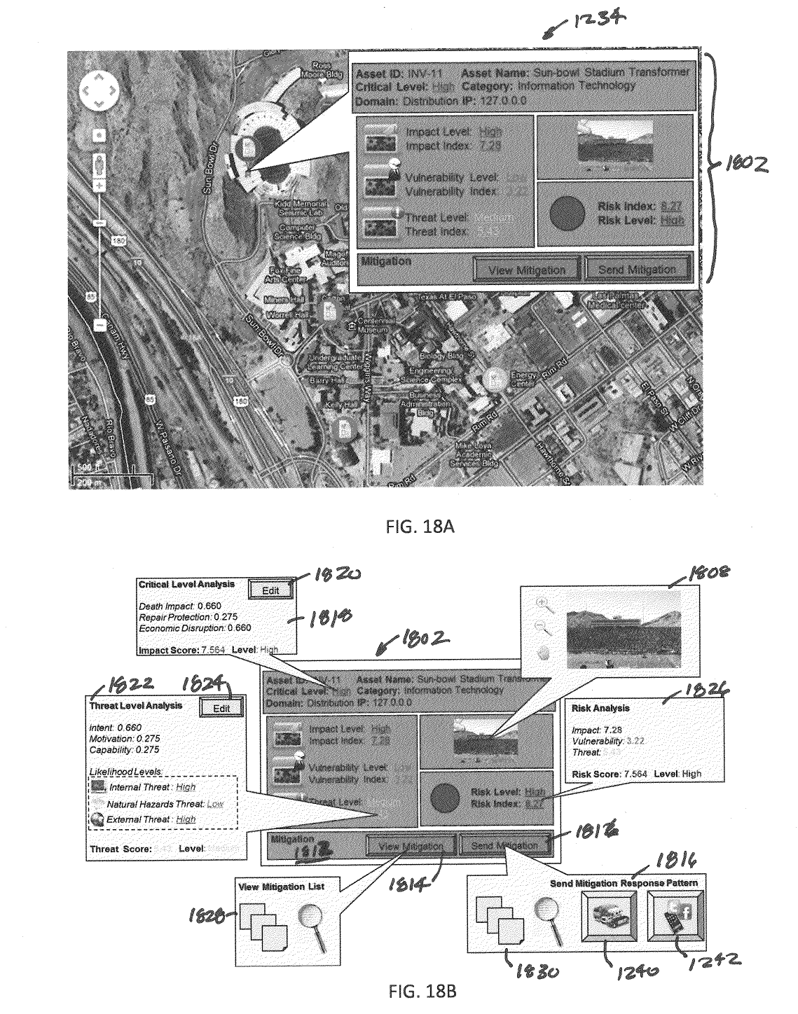

FIG. 18A depicts an example of a geospatial visualization 1234 of risk factors for the critical assets. In the geospatial representation 1234, critical assets are represented as circles with an icon in the center. The icon colors are modified at near-real time based on the risk level for the critical asset; Red is used for high risk, Yellow for medium risk and Green for low risk level. Each circle, when clicked, displays a dialog box 1802 that allows users to visualize detailed risk information about the asset.

FIG. 18B shows that the detailed information dialog box 1802 is divided in five major areas. The general information area 1804 provides the users with generation information about the asset such as: asset id, asset name, criticality level, IT or OT category, power grid domain, and IP number, if available. The risk assessment area 1806 provides information about impact levels and indexes, vulnerabilities levels and indexes, and threat levels and indexes. The values for the risk assessment area are calculated by the risk assessment modules depicted in FIG. 12. The live webcam feed area 1808 allows users to monitor the physical state of the critical infrastructure by using real-time webcam feeds, if available. The risk status area 1810 provides the users with visual feedback about the risk status associated with the critical asset. The risk status area 1810 provides the risk index and level, and a visual status for the risk level, a red circle for high risk level, a yellow circle for medium risk level, and a green circle for low risk level. The mitigation area 1812 allows users to view mitigation response patterns 1814 for high risk levels. The mitigation area 1812 also allows users to send 1816 the response patterns 1814 to emergency response teams 1240 and to social networks users 1242. The detailed information dialog box 1802 can provide further information about the risk analysis by allowing the users to click on specific components on the different areas on the dialog.

Clicking on the hyperlinks provides extra information about the reading. For instance, clicking on the critical level value hyperlink, allows a user to determine how such critical level was calculated 1818. In addition, the user can click the edit button 1820 on the information dialog and he/she is directed to the module in the architecture that calculates such values. Similarly, clicking on the threat index value hyperlink 1806 also provides the details of how such index was calculated 1822 and the edit button 1824 allows the user to go back to the threat aggregation and analysis module used to calculate such values. Going back to the threat aggregation and analysis module also allows the user to view the raw data used to calculate the threat levels. The impact level and vulnerability level hyperlinks behave similarly to the threat level analysis hyperlink. Clicking the live webcam feed 1808 on the detailed information dialog 1802 opens up a separate screen that allows further detailed analysis of the video feeds. The risk analysis hyperlink 1810, when clicked, aggregates the final values from the threat, vulnerability and impact and displays the resulting risk level and index 1826. The view mitigation button 1814 on the detailed information dialog 1802, allows users to see a list of possible mitigation response processes that can be used to address the critical infrastructure risk 1828. The send mitigation button 1816, allows users to select a set of mitigation response processes 1830 and send them directly to dispatched emergency teams 1240 or to social networks users 1242.

Now referring back to FIG. 12, the risk mitigation subsystem 1206 is composed of a situational response module 1236 and a semantic data repository 1238. The semantic data repository 1238 contains risk-specific mitigation procedures that can be used to mitigate risks associated with the critical assets of interest. Given that risks can be interrelated, the data repository 1238 must take advantage of its semantic capabilities to aggregate procedures that best solve the complex risk situations. The situational response module 1236 takes as input a list of risk and risk levels and queries the semantic data repository 1238 for the best risk mitigation procedure, or set of procedures, that address the risk. If the risk derives into an emergency event, the situational response module 1236 sends the emergency procedure to emergency response teams 1240 and to social-networks users 1242 if needed. Otherwise, the risk mitigation procedure is locally provided to the user.

The purpose of the controller system 1208 is the reduction of the coupling between the major VARM systems to improve the extendibility of the software implementation. The controller module 1244 is the only component of the VARM Controller Subsystem 1208. The controller module 1244 allows the risk assessment 1202, visualization 1204 and mitigation 1206 systems to interact with each other. The controller module 1244 uses geospatial-risk-analysis Common Information Models (CIM) to represent and exchange the data between the different subsystems. The controller module 1244 also allows the VARM architecture to be extended by allowing future subsystems to integrate with the current VARM architecture without having to modify the architecture or the data CIMs.

The present invention will now be described with respect applying the VARM process to critical assets for OT infrastructures in general and is not specific to any particular sector, domain, or technology. Note that the following embodiment can be applied to and modify the previous embodiment and vice versa.

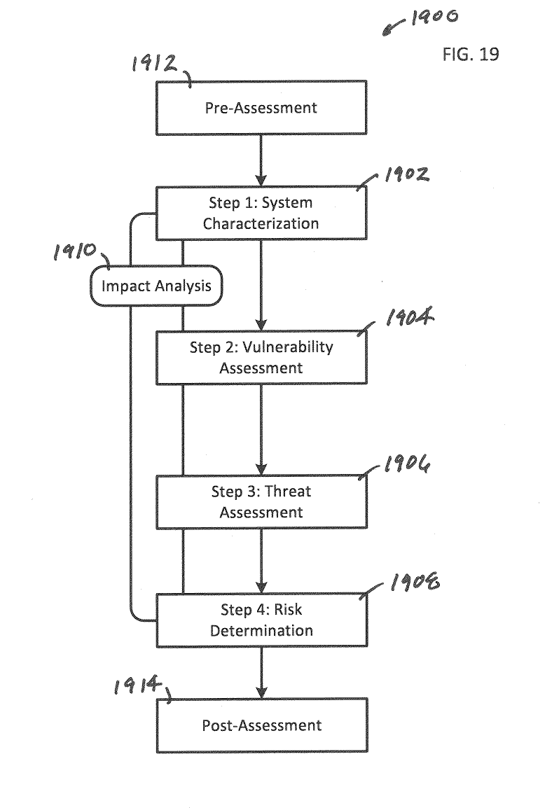

Referring now to FIG. 19, a flow chart of the VARM process 1900 in accordance with another embodiment of the present invention is shown. The VARM process 1900 for OT infrastructures consists of four steps: system characterization 1902, vulnerability assessment 1904, threat assessment 1906, and risk determination 1908. System Characterization 1902 is the first step of the assessment and consists of the identification of critical assets, operational technology (OT) infrastructure, and associated critical cyber assets. In addition, a criticality impact analysis 1910 is performed for the identified critical assets, which is subsequently used as a driver for risk determination 1908. Vulnerability Assessment 1904 is the second step of the assessment and is to identify the relevant vulnerabilities of the critical cyber assets identified in the System Characterization stage 1902. These vulnerabilities are determined by analyzing the configuration of the critical cyber assets. Threat Assessment 1906 is the third step of the assessment and is to identify the likelihood of a set of cyber threats compromising the cyber vulnerabilities of a set of critical cyber assets. Risk Determination 1908 is the fourth step of the assessment and is to calculate the risk magnitude of the identified critical assets. The risk magnitude is calculated as a function of the asset's criticality impact, threat, and vulnerability. Once the assessment is completed, an assessment report with findings is provided to the customer in a post-assessment 1914.

The scope and objectives of the assessment are defined with the customer in a pre-assessment meeting 1912. Once the scope and conditions have been defined, a Subject Matter Expert (SME) support team, with members from the following departments, is formed: Security, Risk management, Regulatory compliance, Operation Technology (OT) operators, Information Technology (IT) technicians, and other members as required. The purpose of the SME team is to provide support, consulting and guidance about the enterprise's operations throughout the VARM process. Communication and information sharing with the SME team take place through the duration of the VARM to ensure that all the required data are provided to the assessment team in a timely matter. Daily or weekly meetings are scheduled to discuss the status of the assessment.

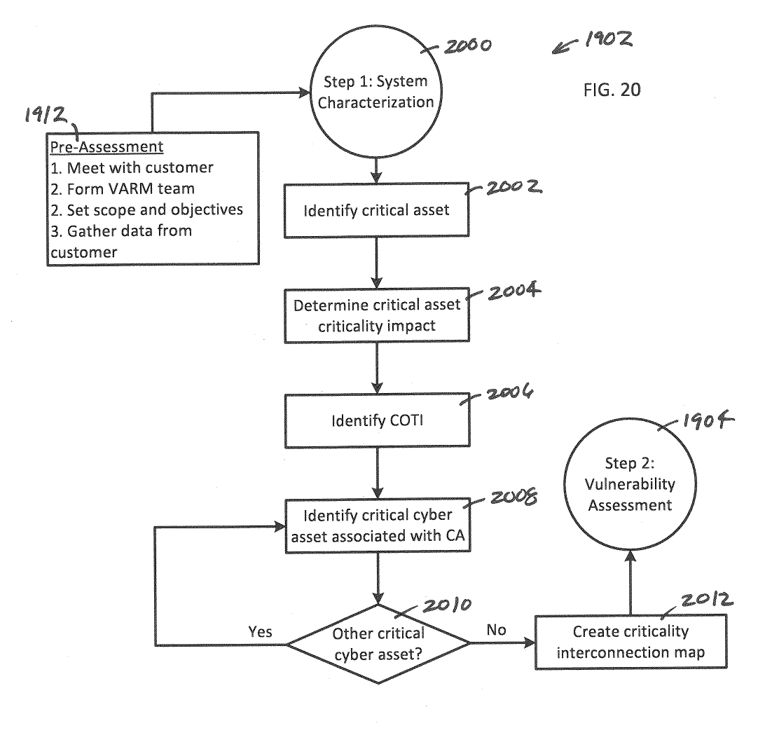

Now referring to FIG. 20, a flow chart showing the system characterization process 1902 in accordance with another embodiment of the present invention is shown. The pre-assessment process 1912 was described above, so the system characterization process 1902 begins in block 2000. The first sub-steps of the system characterization step 1902 identify enterprise critical assets, critical OT infrastructure, and critical cyber assets in block 2002. These processes generally do not populate an inventory of all the assets at an installation, but just those critical to the operation of such infrastructure. Critical assets (CA) are physical components essential to the operation of the installation. Critical assets are identified by the customer in collaboration with the assessment team and evaluated based on their importance to the mission, economics, and safety of the enterprise. The following asset identification information is collected for the CA:
Asset name/ID is the unique name identifier of the technology or equipment in the infrastructure;
Asset location is a particular place or site where an asset is located; and
Asset function is a short description of the role or purpose of the asset to the infrastructure.
   Walk-throughs, review of technical descriptions, and various relevant diagrams are used to collect the asset identification information of CAs. This process also serves as a method for identifying additional CAs that are not initially identified by the customer.

A criticality impact analysis of critical assets is performed in block 2004. Impact analysis is a technique designed to determine the potential value of a critical asset. The level of impact is based on the magnitude of disruption that can be expected in terms of safety, economic, and mission. Quantitative values are assigned for the criticality of an asset through the evaluation of a set of metrics to obtain the impact if the asset is compromised. The criticality for CAs is evaluated by selecting values from the metrics shown in Table 14 based on input from the SME team.

TABLE 14
Criticality Evaluation Metrics

| Metric | | Value |
|---|---|---|
| | Description (Safety) | |
| Low (L) | There is no injury, illness, and deaths when asset | 0.0 |
| | is compromised. | |
| Medium (M) | There is an injury and/or illness to a human(s) if | 1.65 |
| | asset is compromised. | |
| High (H) | There is a severe injury, illness and/or death of a | 3.33 |
| | human if asset is compromised. | |
| | Description (Mission) | |
| Low (L) | There is a small mission disruption and daily | 0.0 |
| | operations can continue if asset is compromised. | |
| Medium (M) | There is a moderate mission disruption and daily | 1.65 |
| | operations are mildly affected if the asset is | |
| | compromised. | |
| High (H) | There is a high operational disruption and daily | 3.33 |
| | operations are completely stopped if asset is | |
| | compromised. | |
| | Description (Economic) | |
| Low (L) | There is low revenue, repairing cost, legal fees, or | 0.0 |
| | protection mitigation cost if asset is | |
| | compromised. | |
| Medium (M) | There is moderate revenue, repairing cost, legal | 1.65 |
| | fees, or protection mitigation cost if asset is | |
| | compromised. | |
| High (H) | There is high revenue, repairing cost, legal fees, | 3.33 |
| | or protection mitigation cost if asset is | |
| | compromised. | |

The criticality impact is calculated by entering the selected metric values into Equation 7. The resulting criticality impact has an approximate range from 0 to 10.

Criticality Impact(I)−Safety+Mission+Economic (7)

Identification of the Critical Operational Technology (OT) Infrastructure (COTI) is performed in block 2006. Critical assets rely on operational equipment to accomplish their mission. Operational equipment is any piece of equipment whose functionality is used to provide some service (e.g. water pumps, solar panel inverters) to a critical asset. Operational equipment typically includes one or more process control systems (PCS). A PCS measures, controls, and provides a view of equipment functions. Some examples of PCS include, but are not limited to, distributed control systems (DCSs), programmable logic controllers (PLCs), remote terminal units (RTUs), intelligent electronic devices (IEDs), networked electronic sensing and control, and monitoring and diagnostic systems [7N].

Some PCS can be remotely accessed by end-point computing devices such as workstations, human machine interfaces (HMI), and application and data servers. Such access is typically accomplished through distributed monitoring and control communication networks such as supervisory control and data acquisition (SCADA) systems [7N]. SCADA communications media includes advanced radio data information services (ARDIS), cellular telephone data services, digital microwave, fiber optics, and multiple address radio (MAS) [8N].

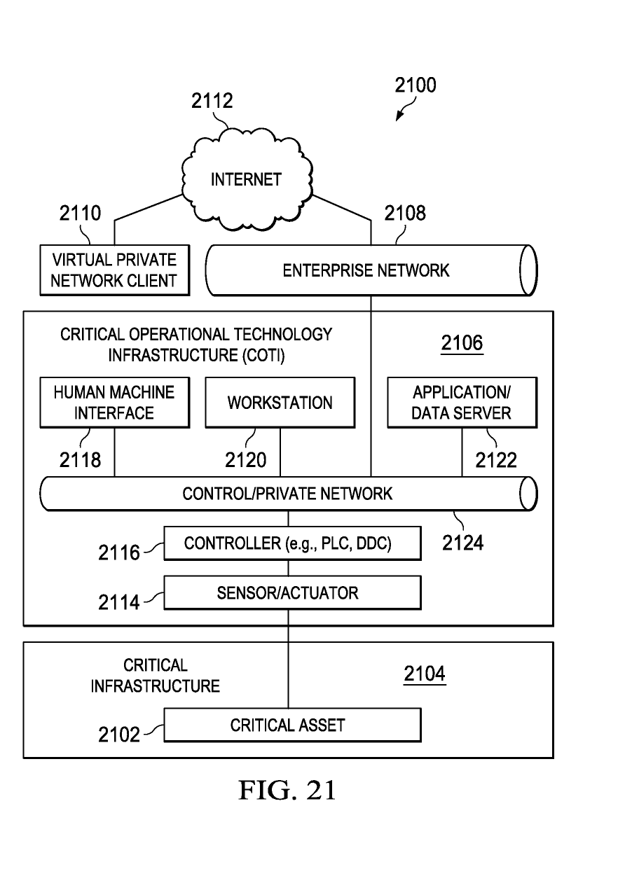

For example, FIG. 21 is a block diagram of a typical component configuration of an OT infrastructure 2100 in accordance with another embodiment of the present invention. A critical asset 2102 within a critical infrastructure 2104 is communicably coupled to a critical operational technology infrastructure (COTI) 2106. The COTI 2106 is communicably coupled to an enterprise network 1208, which is communicably coupled to a virtual private network (VPN) client 2010 via the Internet 2112 or other wide-area network. The COTI 2106 includes a sensor/actuator 2114 communicably coupled to the critical asset 2102 and a controller (e.g., PLC, DDC, etc.) 2116. The controller 2116, human machine interface (HMI) 2118, workstation 2120, application/data server 2122, enterprise network 2108 and other devices/systems are communicably coupled together via a control/private network 2124.

The second sub-step in the System Characterization step is to identify the assets that build the critical operational technology infrastructure (COTI) that supports the critical asset under evaluation. The elements of the COTI are identified in block 2006 from a variety of diagrams, physical walk-throughs, documentation, and interviews with the SME team. The following are examples of data sources that can help to obtain an infrastructure topology.
Blueprints: A technical drawing that documents the architecture and/or engineering design of a process control system.
One-line diagrams: A blueprint for the electrical system that includes cable voltages and sizes, power and control transformers, feeder breakers, switches, relays, and cutouts, etc.
Block diagrams: A block diagram represents the relationships between signals in control systems.
Network topology: A schematic that depicts the nodes and connections amongst devices in the network.
   The subsequent step 2008 is to determine which of the identified COTI's assets are critical cyber assets.

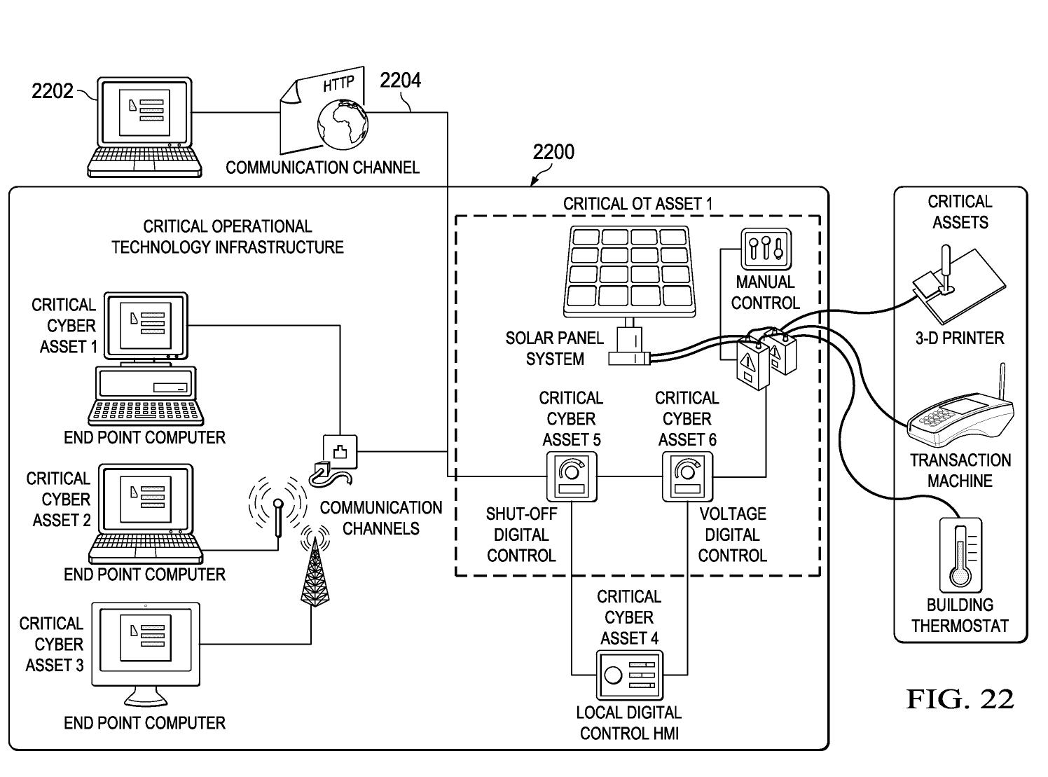

Identification of Critical Cyber Assets (CCA) is performed in block 2008. Critical cyber assets (CCAs) are network routable electronic components that are part of control or data acquisition systems that monitor, manage or command operational equipment. Such CCAs are physically distributed through a COTI. FIG. 22 depicts an example of distributed critical cyber assets on a COTI 2200 that support a solar panel system that provides electricity to a 3-D printing shop. The COTI 2200 includes various end point computers (Critical Cyber Assets 1, 2 and 3), a local digital control HMI (Critical Cyber Asset 4), a shut-off digital control (Critical Cyber Asset 5), a voltage digital control (Critical Cyber Asset 6) and a Critical OT Asset 1. Critical OT Asset 1 includes a solar panel system manual control, Critical Cyber Asset 5, Critical Cyber Asset 6 and other Critical Assets (3-D Printer, Transaction Machine and Building Thermostat). The COTI 2200 is monitored from system or device 2202 via communication channel 2204.

The following process is used to identify CCAs in a COTI:
Step 1. Identify the operational equipment used to serve the critical assets of interest.
Step 2. Identify the process control systems (PCS) manipulating the operational equipment identified in step 1.
Step 3. Identify end-point computer devices used to access the process control systems identified in step 2.
Step 4. Collect cyber asset identification information for assets (dubbed as Critical Cyber Assets from now on) identified in steps 2 and 3.

The following cyber asset identification information is collected for each CCA:
Asset name/ID is a unique name identifier of the technology or equipment in the infrastructure.
Asset location is a particular place or site where an asset is located.
Asset function is a short description of the role or purpose of the asset to the infrastructure.
IP address is a numerical label assigned to each device participating in a computer network that uses the Internet Protocol for communications [8N].

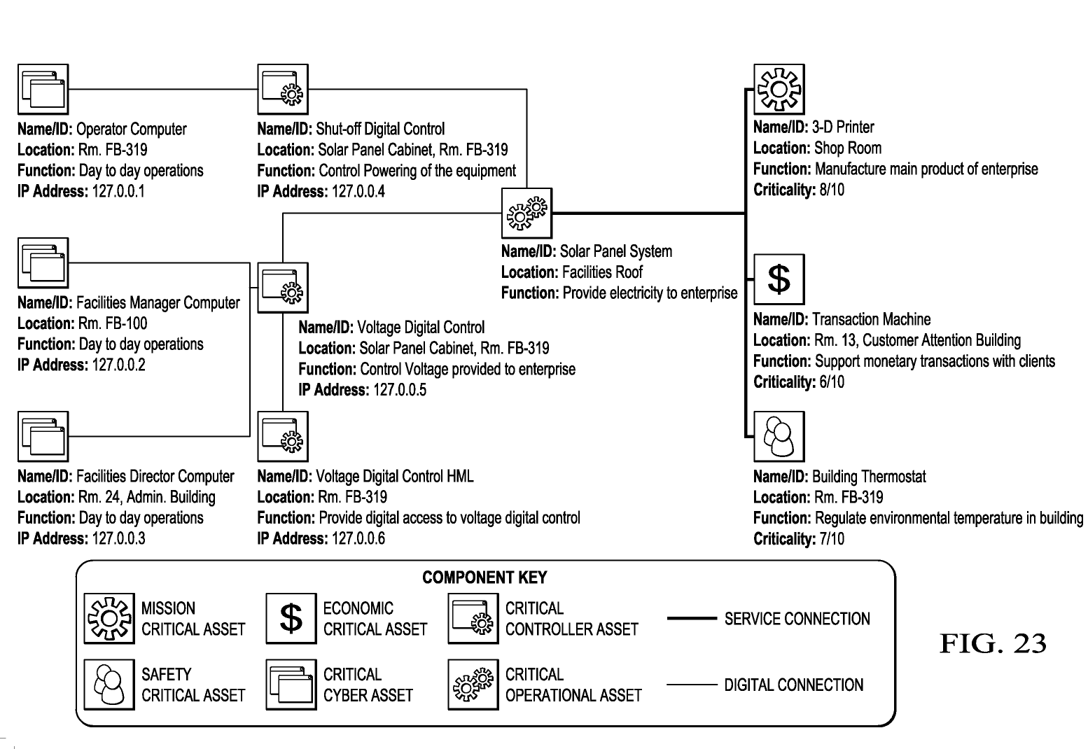

Once a critical cyber asset associated with a CA is identified in block 2008, if other critical cyber assets exist, as determined in decision block 2010, the process returns to block 2008 to identify the next critical cyber asset associated with a CA. If, however, no other critical cyber assets exist, as determined in decision block 2010, a criticality interconnection map generated once all the critical cyber assets are identified and processed is created in block 2012. A criticality interconnection map captures the relationship between critical assets and the operational and critical cyber assets in the COTI. FIG. 23 depicts an example of a criticality interconnection map. The criticality interconnection map makes a distinction between process control systems (Critical Controller Assets) and end-point computers (Critical Cyber Assets) when representing CCAs. Thereafter, the process proceeds to step 2 for the vulnerability assessment 1904.

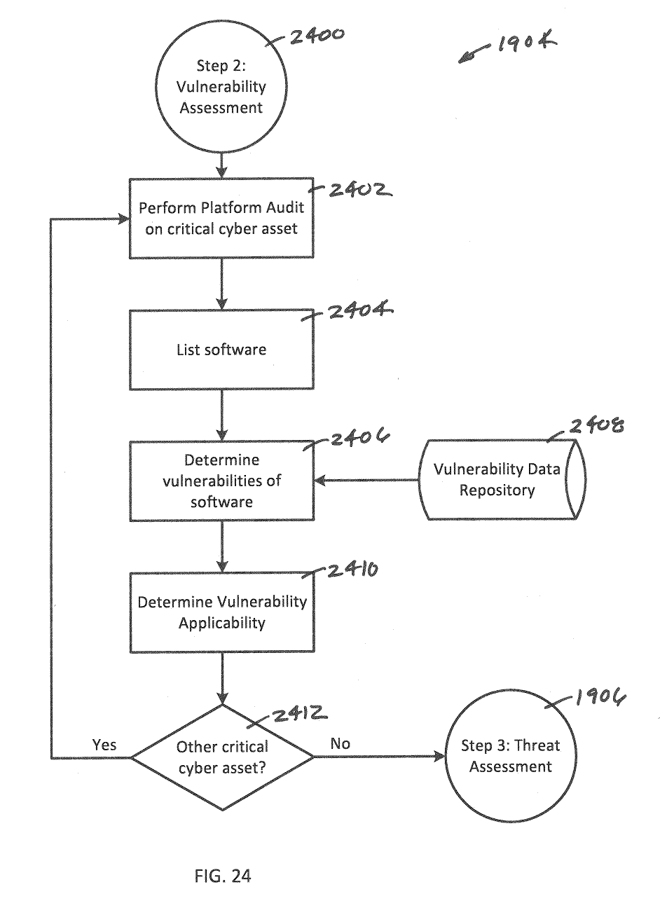

Referring now to FIG. 24, a flow chart showing the vulnerability assessment process 1904 in accordance with another embodiment of the present invention is shown. The second step of the VARM process is to identify the relevant cyber vulnerabilities of the critical cyber assets recognized in the System Characterization step 1904 begins in block 2400. These vulnerabilities are determined by looking at the configuration of the critical cyber assets and by determining the software and network ports in use. A network audit can provide validation of which vulnerabilities can be exploited and applied to the CCAs. The platform and network vulnerabilities that are found for a particular CCA are sorted for use in the Vulnerability Factor calculation in the Threat Assessment step 1906 of the VARM.

More specifically, a platform audit is performed on a critical cyber asset in block 2402, a list of software installed on the CCA is populated in block 2404, vulnerabilities of the software are determined in block 2406 using a vulnerability data repository 2408, and the vulnerability applicability is determined in block 2410. If other critical cyber assets exist, as determined in decision block 2412, the process returns to block 2402 to perform the platform audit on the next critical cyber asset. If, however, no other critical cyber assets exist, as determined in decision block 2412, the process proceeds to step 3 for the threat assessment 1906.

In the step of identifying the platform vulnerabilities, a list of software installed on each CCA is populated with data collected through software platform audits. The data can be supplied by a vendor, a client, or a validated service provider. Network port connectivity data can also be collected as part of this step. Information that is gathered in this step relates to the following criteria:

(1) Platform and Software/Firmware Vulnerabilities: Software and firmware design, development and deployment can have vulnerabilities that might be prone to cyber attacks. Software and firmware development include vulnerabilities in code quality, authentication, cryptography, general logic errors and password management. Platform vulnerabilities in regard to software or hardware units that are compromised in areas of security architecture and design, inadequate malware protection from software attacks and software vulnerabilities. These software vulnerabilities include categories on design, implementation, operation, and configuration [10N]. The Common Vulnerability and Exposure (CVE) [1]N] specification is used to establish a common identifier for vulnerability as well as some other descriptions from the Common Weakness Enumeration (CWE) [12N] and vulnerability categories from the Open Web Application Security Project (OWASP) [13N] [10N].

(2) Categorization of Platform Vulnerabilities: The software list is analyzed and categorized according to three base criteria defined in Table 15. These categories determine the focus and priority needed to analyze the software present on the CCA. Each entry in the software list is then compared to the baselines in vulnerability data repository and then is ranked according to severity. As an example, a CVSS score can be used to determine the severity.

Vulnerabilities at this point can be optionally exercised by comparison to the network or security information and event management (SIEM) profiles. If the network port connectivity was included, these profiles can be compiled by the information collected during the platform audit of the Vulnerability Assessment.

TABLE 15
Software Categorizations for Vulnerability Ranking

| Category | Description |
|---|---|
| Vulnerable | Software that has a well-known flaw or bug that a |
| | threat can or has attacked before. |
| Suspicious | Software that is on a blacklist, is normally used for |
| | either nefarious or Peer 2 Peer purposes, or has open |
| | ports or active connections to untrusted or unknown |
| | computers and devices. |
| Common | Software that is well known and used every day by |
| | many individuals that is typically considered to be safe |
| | to use. |

Network vulnerabilities are identified using a network audit, which can provide additional information relevant to determining the applicability of reported vulnerabilities. This audit is customized to the needs of the SME team and must report information about the communications that take place on the network. For example, the information collected may include: network logs, login information, protocols in use, and communication paths used by the critical cyber asset. This data, when collected, can be used to validate the existence or relevance of the vulnerabilities reported in the platform audit. A short description of network vulnerabilities follows.

Networks are defined by connections between multiple locations or organizational units and are composed of many differing devices using similar protocols and procedures to facilitate exchange of information. Vulnerabilities exist within the network when the data exchange does not conform to the required standards and compliance policies. Network vulnerabilities can include inadequate integrity checking, network segregation, inappropriate protocol selection, weakness in authentication, physical/remote access to device, etc. [10N]. These vulnerabilities are prioritized by the categories described in Table 16. Each entry is then compared to the baselines in the related data repository and is ranked according to severity.

TABLE 16
Network Categorization for Vulnerability Ranking

| Category | Description |
|---|---|
| Port Activity | A computer or device has a communication port(s) |
| | open and/or responds to undesired communications |
| Remote Access | The device is on a network that is visible to users |
| | outside of the intended area. Improper network |
| | isolation or access control. |
| Common | Weak passwords, unauthorized access, or improper |
| Configuration | cabling or connections to the communications |
| Weakness | mediums (RS485, Ethernet, 802.11x, etc.) |

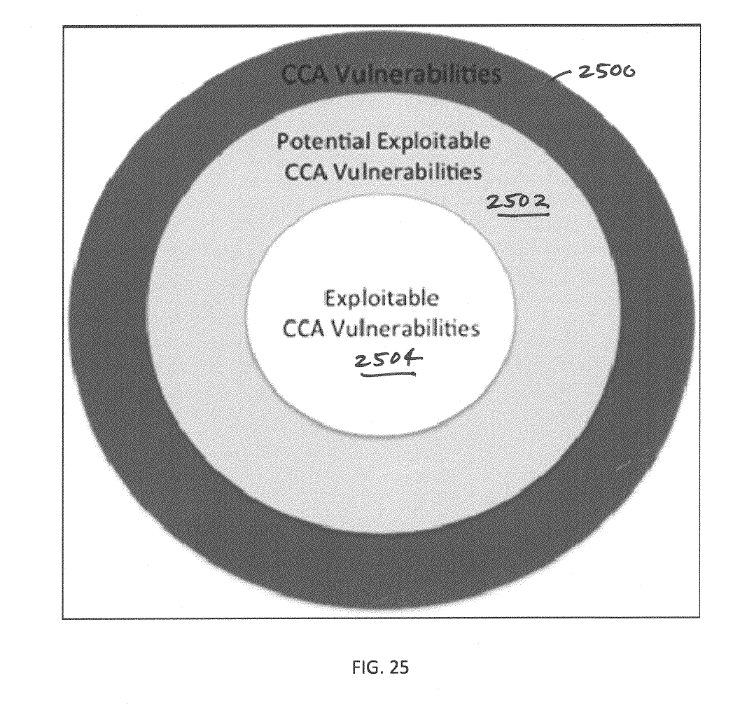

The vulnerability assessment step 1904 helps identify the number of true potential vulnerabilities that might be exploited by a cyber threat. FIG. 25 depicts the reduction of vulnerabilities distributions as the VARM process is conducted. The CCA Vulnerabilities region 2500 contains all the possible, theoretical, vulnerabilities contained by the CCAs. After the vulnerability assessment process, the number of CCA potential vulnerabilities 2500 is reduced to a smaller list of potential exploitable CCA Vulnerabilities 2502. Notice that by definition, it is impractical to ensure that all the CCA vulnerabilities 2500 are captured because it would require exhaustive testing coverage of the software code, which is not feasible. Once all the potential exploitable CCA vulnerabilities 2502 are discovered (the last deliverable of this step), the list of exploitable CCA vulnerabilities 2504 is further reduced based on the capabilities of the threat sources and type of threat attack vector (process conducted in the Threat Assessment step 1906).

The final deliverable of the Vulnerability Assessment step 1904 is a prioritized list of uncovered potential CCA vulnerabilities that can be exploited by a threat source given the appropriate capabilities.

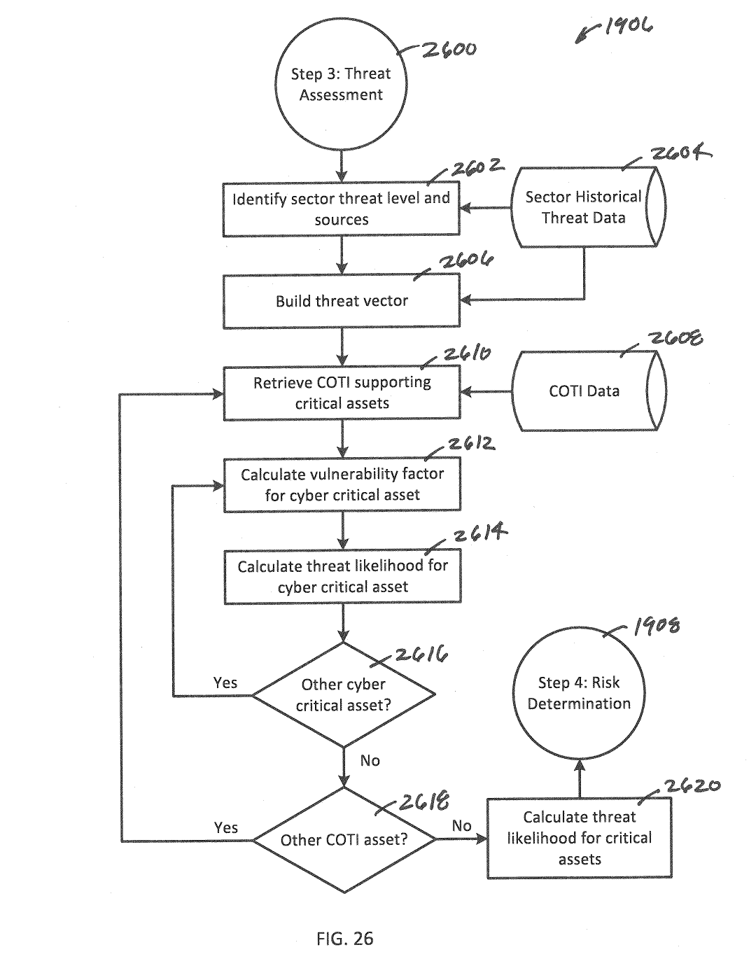

Now referring to FIG. 26, a flow chart showing the threat assessment process 1906 in accordance with another embodiment of the present invention is shown. The third step of the VARM process is to determine the threat likelihood associated with a critical asset given the likelihood of a set of threat sources compromising the cyber vulnerabilities on the critical cyber assets supporting such critical asset.

The likelihood of threat for specific vulnerability is based on:
1. Threat level specific to the sector, to which the enterprise belongs to, according to historic cyber activities of the threat sources. (Motivation)
2. Number of vulnerabilities that can be compromised by the threat sources. (Capability)
3. Variety of threat vectors used by threat sources. (Intent)
   A threat vector can be defined as the possible actions and attacks that a threat source can use to compromise the exposed cyber vulnerabilities. Typically, the intent of the threat source, e.g. stealing data or damaging equipment, determines the type of attacks included in a threat vector.

The threat assessment process 1906 begins in block 2600. Sector threat level and sources are identified in block 1602 using sector historical threat data 2604. The goal of this step is to obtain a threat level for the type of sector being evaluated and to identify the potential threat sources that might be interested in compromising such sector. In this context, a sector is defined as a group of infrastructures, cyber and physical, that conducts a similar mission through similar operations, equipment, and personnel capabilities. Examples of sectors include utilities, higher education institutions, military bases, etc.

Every sector has a specific threat level according to the sector's mission, economic, or critical impact as perceived by the threat sources. A sector's threat level can be determined by analyzing historical cyber-attack data 2604 associated with the different sectors.

Cyber-attack patterns can be identified using data analytics, and such patterns can be used to determine which sectors are perceived as more appealing to threat sources. Such attack patterns change with time, so a sector's threat level must be updated as frequently as possible. When a sector is more appealing, the threat level is higher for this specific sector. The sector threat level becomes the maximum value that any critical asset that belongs to an infrastructure within an identified sector can have.

Analysis of historical cyber-attack data 2604 can also identify threat sources applicable to specific sectors. This work focuses on hacktivism, cybercrime, cyber warfare, and cyber espionage activities. Table 17 defines each of the threat sources categories. The applicable threat sources will be used to determine the types of attacks that can be used to exploit the cyber vulnerabilities in the CCAs that support the critical assets.

TABLE 17
Category Descriptions for Threat Sources [14]

| Category | Description |
|---|---|
| Hacktivism | Includes those cyber-attacks performed to promote |
| | (or motivated by) political or social scopes. |
| Cyber | Includes those cyber-attacks performed to harm |
| Crime | people, by exposing information or stealing data, |
| | for lucrative purposes, or simply “for the lulz”. |
| Cyber | If a state illicitly infiltrates an enemy nation |
| Warfare | to damage systems and/or information, it executes |
| | an action of cyber war. |
| Cyber | If a state illicitly infiltrates an enemy nation |
| Espionage | to steal information or project plans. |

Once the threat sources are identified, the next step is to determine the type of a) attacks that each of the applicable threat sources could use to attack the cyber vulnerabilities in the CCAs (threat vectors) in block 2606. Current threat vectors (type of attacks) can be determined based on the historical cyber-attack data 2604. A sample list of the type of attacks used by threat sources is provided in Table 18. The list is not comprehensive, thus the approach can be extended to be used for emerging types of attacks.

TABLE 18
Category Descriptions for Frequently
Occurring Exploit Vectors [15]

| Category | Description |
|---|---|
| DoS | Denial of Service. An attack that temporarily or |
| | indefinitely interrupts services of a computer or |
| | device. |
| Code | Ability of an attacker to execute a command on a |
| Execution | target machine or process. |
| Overflow | An overrun of a computer memory buffer's boundary |
| | into adjacent memory as a result of a malicious |
| | exploit or software bug. |
| SQL | Technique targeted to database driven applications |
| Injection | that introduces new SQL segments into the original |
| | SQL statements to cause undesired information |
| | retrieval or corruption of the underlying database. |
| XSS | Cross-site scripting. An attacker execution of new |
| | scripts within the context of a vulnerable web |
| | application. |
| Directory | HTTP exploit in which an attacker uses the software |
| Traversal | on a Web server to access data in a directory other |
| | than the server's root directory. |
| HTTP | Failure of an application or its environment to |
| Response | sanitize input values. |
| Splitting | |
| Bypass | An alternative digital passage that allows an attacker |
| Something | to avoid a certain security measure. |
| Gain | Capability of an attacker to obtain information from |
| Information | a system. |
| Gain | Capability of an attacker to obtain access credentials |
| Privileges | for a system. |
| CSRF | Cross-site request forgery. An attacker can transmit |
| | unauthorized commands from a user that the victim |
| | website trusts. |
| File Inclusion | An attacker includes a remote file into a web application |
| | through a script on the web server. |
| Defacement | An illegal altering of the content of a web site or |
| | publicly editable repository. |

The threat likelihood calculations (blocks 2610-2620) will now be described. COTI data 2608 supporting the critical assets is retrieved in block 2610, a vulnerability factor for the cyber critical asset is calculated in block 2612, and a threat likelihood for the cyber critical asset is calculated in block 2614 (see details below). If other critical cyber assets exist, as determined in decision block 2616, the process returns to block 2612 to calculate a vulnerability factor for the next cyber critical asset. If, however, no other cyber critical assets exist, as determined in decision block 2616, and if another COTI asset exists, as determined in decision block 2618, the process returns to block 2610 to retrieve COTI data for the next COTI asset. If, however, no other COTI assets exist, as determined in decision block 2618, a threat likelihood for the critical assets is calculated in block 2620 and the process proceeds to step 4 for the risk determination 1908.

To determine the capabilities of the threat sources, a vulnerability factor must be calculated for every critical cyber asset. The vulnerability factor is the percentage of vulnerabilities that are prone to the attacks contained on the threat vector. Such vulnerability factor can be calculated by using Equation 8.

$${V}_{f} = \frac{{V}_{e}}{{V}_{t}} \qquad ( 8 )$$

where:
V_{f} is the Vulnerability Factor;
Vₑ is the Total Number of exploitable vulnerabilities; and
Vₜ is the Total Number of uncovered potential vulnerabilities.

The threat likelihood for a critical asset is the likelihood of one or more cyber vulnerabilities being targeted. The initial value of the threat likelihood for the critical cyber asset is equal to the sector threat level, i.e. in the case when all of the vulnerabilities are prone to attacks. Because typically not all of the vulnerabilities can be targeted by a threat source's capabilities, the original threat likelihood remains the same or is reduced depending on the number of exploitable vulnerabilities. Thus, the threat likelihood for each critical cyber asset can be calculated by using Equation 9.

T_{cca}=Tₛ*V_{f} (9)

where:
T_{cca} is the Critical Cyber Asset Threat Likelihood;
Tₛ is the Sector Threat Level; and
V_{f} is the Vulnerability Factor.

The threat likelihood for critical assets depends on the likelihood of an attack on the CCAs that serve such critical assets. Threat likelihood for a critical asset can be interpreted in two ways: (1) the likelihood when all the cyber critical assets are being targeted at the same time; and (2) the likelihood when only the most vulnerable CCA is being targeted. Both scenarios can compromise the critical asset.

In the case when all of the assets are being targeted at the same time, Equation 10 should be used.

$${T}_{CA} = \frac{{\sum }_{i = 1}^{∞} {( {T}_{s} * {V}_{f} )}_{i}}{i} \qquad ( 10 )$$

where:
T_{CA} is the Critical Asset Threat Likelihood;
Tₛ is the Sector Threat Level;
V_{f} is the Vulnerability Factor; and
i is the Number of Critical Cyber Asset.

In the case when only the most vulnerable critical cyber asset is targeted, Equation 11 should be used.

T_{CA}=Max((Tₛ*V_{f})₁ . . . (Tₛ*V_{f})ᵢ) (11)

where:
T_{CA} is the Critical Asset Threat Likelihood;
Tₛ is the Sector Threat Level;
V_{f} is the Vulnerability Factor; and
i is the Number of Critical Cyber Asset.

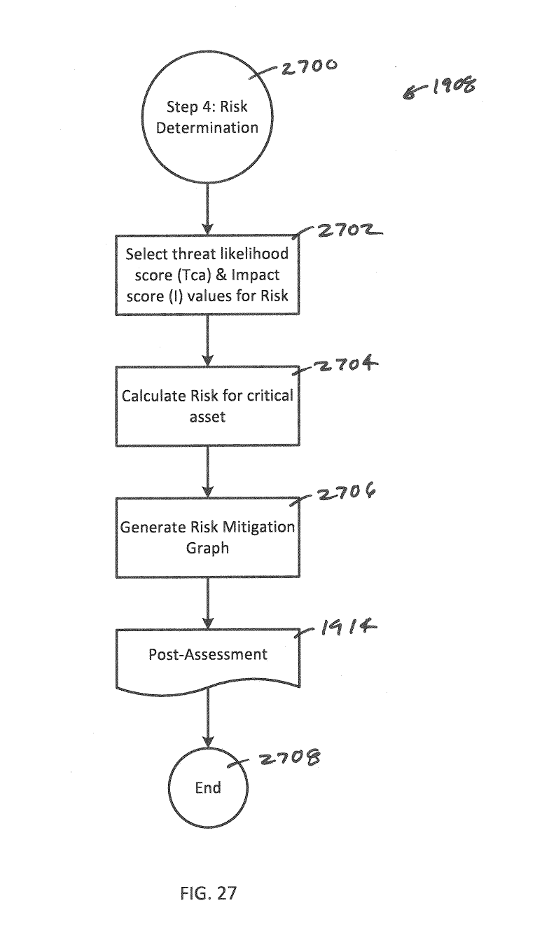

Referring now to FIG. 27, a flow chart showing the risk determination process 1908 in accordance with another embodiment of the present invention is shown. The last step of the VARM process is the calculation of the risk of a critical asset being compromised based on specific sector threats and vulnerabilities of the associated critical cyber assets. The calculated risk captures the expected losses given the current cyber threats and cyber vulnerabilities of a system. Typically, risk is calculated as a function of threat, vulnerability, and impact [3][16][17].

The risk determination process 1908 begins in block 2700. A threat likelihood score (T_{CA}) and Impact score (I) values for risk are selected in block 2702. A risk for the critical asset is calculated in block 2704 and a risk mitigation graph is generated in block 2706. A post-assessment is performed in block 1914 and the process ends in block 2708. These steps will be described in more detail below.

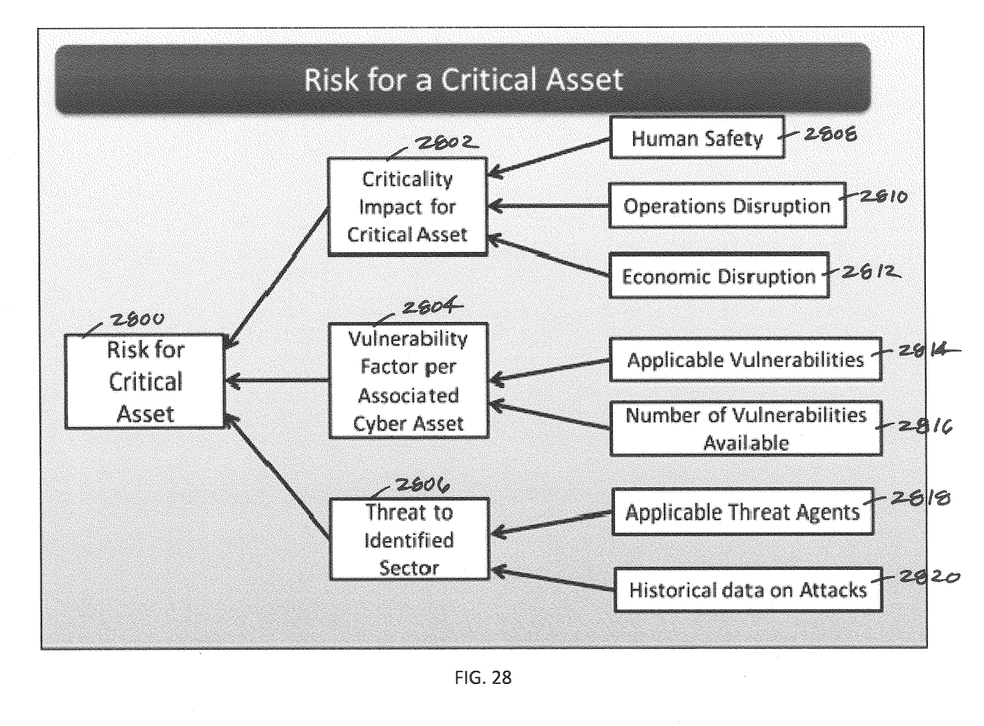

Risk consists of a threat, vulnerability, and criticality impact score for each of the CCAs associated to a critical asset. These values are obtained from the System Characterization 1902 and Threat Assessment 1906. Risk is determined for a critical asset with the applicable threats and vulnerabilities. FIG. 28 shows the development of how risk is formed throughout the process. Risk for the critical asset 2800 is based on criticality impact for the critical asset 2802, vulnerability factor per associated cyber asset 2804, and threat to the identified sector 2806. Criticality impact for the critical asset 2802 can be based on human safety 2808, operations disruption 2810 and economic disruption 2812. Vulnerability factor per associated cyber asset 2804 can be based on applicable vulnerabilities 2814 and number of available vulnerabilities 2816. Threat to the identified sector 2806 can be based on applicable threat agents 2818 and historical data on attacks 2820.

Equation 12 was developed to assess the cyber security risk for a critical asset with its associated critical cyber assets with multiple threats and vulnerabilities. The risk function is expressed as a product of threat likelihood (which already includes the vulnerability factor) and criticality impact.

Risk(R)=I*T_{CA} (12)

where:
I is the Criticality Impact of losing a critical asset; and
T_{CA} is the Critical Asset Threat Likelihood.
   Note: The value for impact is obtained from the Criticality Impact Analysis during System Characterization 1902. The value of T_{CA} contains vulnerability and threat data obtained in the equations in the Threat Assessment 1906.

For a critical asset, T_{CA} represents the likelihood of threat based on the applicable vulnerabilities discovered in the associated critical cyber assets and the sector to which the enterprise belongs. This is then multiplied by I (Criticality Impact) to obtain the risk to the critical asset if the CCAs are compromised. The overall risk is dimensionless. However, risk analysis can also be represented with respect to monetary cost, operational downtime, and safety in terms of number of injuries/deaths.

As discussed above with respect to the Threat Assessment 1906, multiple threat scenarios can be created for one critical asset depending on the number of associated critical cyber assets and cyber vulnerabilities. Therefore, the applicable option from the two available threat scenarios must be chosen accordingly for risk calculation. This will translate to a risk that will illustrate expected losses given current threats and vulnerabilities in the system.

Based on the two threat scenarios from the Threat Assessment 1906:
Threat Scenario 1: All assets targeted at the same time. The risk represents the average of applicable threats and vulnerabilities of every critical cyber asset that is connected to the critical asset in question.
Threat Scenario 2: The most vulnerable critical cyber asset is targeted. The risk represents the applicable threats and vulnerabilities of the most vulnerable critical cyber asset linked to the critical asset in question.

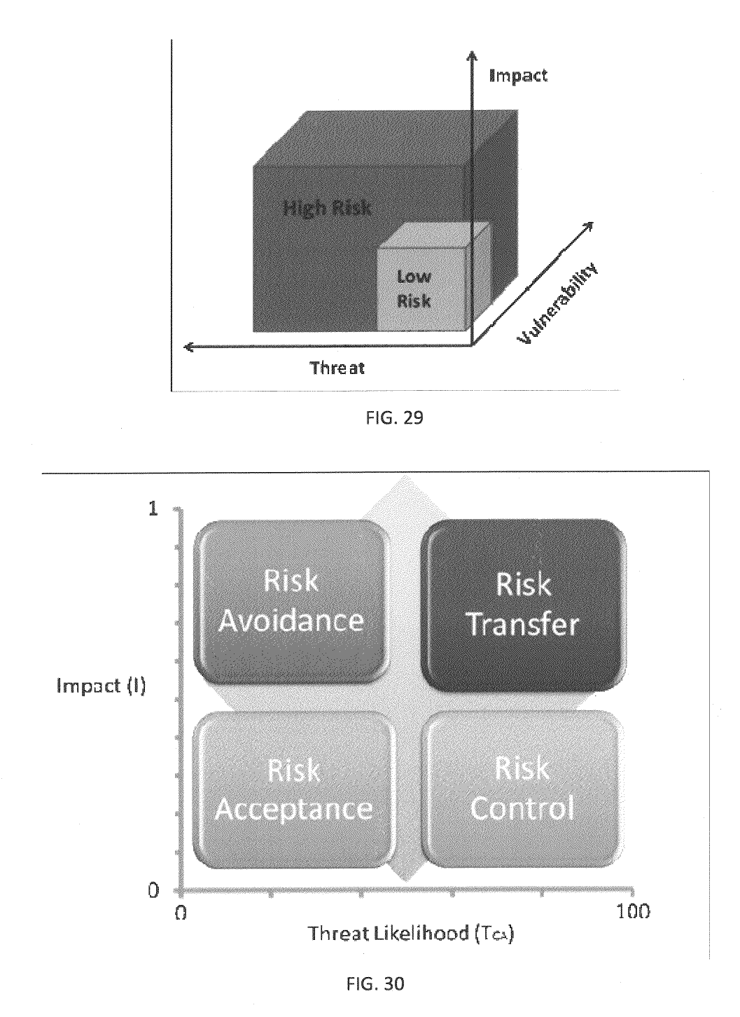

The magnitude of the risk is directly dependent on the values for the obtained impact, threat, and vulnerability. Therefore, the increase or decrease in the value for the impact, threat, or vulnerability will directly affect the magnitude of the risk from cyber-attacks as seen on FIG. 29. Risks can be managed by one of four distinct methods listed and described in Table 19[17].

TABLE 19
Risk Mitigation Strategies [17]

| Strategy | Definition |
|---|---|
| Risk | An exploit or implicit decision not to take an |
| Acceptance | action that would affect a particular risk. |
| Risk | A strategy or measure which effectively removes |
| Avoidance | the exposure of an organization to a risk. |
| Risk | Deliberate actions taken to reduce a risk's |
| Control | potential for harm or maintain the risk at an |
| | acceptable level. |
| Risk | Shifting some or all of the risk to another entity, |
| Transfer | asset, system, network, or geographic area. |

The risk calculation results are subsequently plotted in a risk mitigation graph as depicted in FIG. 30. A risk mitigation graph is composed of four quadrants (Risk Avoidance, Risk Transfer, Risk Acceptance, and Risk Control), each of which represents a risk mitigation strategy to be followed according to Table 19. The independent variable captures the threat likelihood of a critical asset; the dependent variable captures the impact value associated with a critical asset. For example, a critical asset falling in quadrant 2 (Risk Transfer) will have a high impact with a high threat likelihood and therefore is necessary to mitigate the risk immediately to minimize the potential repercussions of an attack.

Risk mitigation graphs are also generated for monetary cost, operational downtime, and safety in terms of number of injuries/deaths. The customer can use the generated risk mitigation graphs to determine strategies to mitigate risk in his/her enterprise. However, it is recommended that the customers conduct a cost-benefit analysis, in addition to the VARM, to evaluate the feasibility of identified mitigation countermeasures.

The primary product of the VARM process is an assessment report (post-assessment 1914). The content of the report includes, but is not limited to, the following items:
Executive summary;
Scope and objectives of the assessment;
List of identified critical assets;
Results of criticality analysis for critical assets in order of importance;
Criticality interconnection map;
List of applicable cyber vulnerabilities affecting Critical Cyber Assets in order of importance;
Results of cyber threats analysis applicable to the OT infrastructure; and/or Risk mitigation graphs.

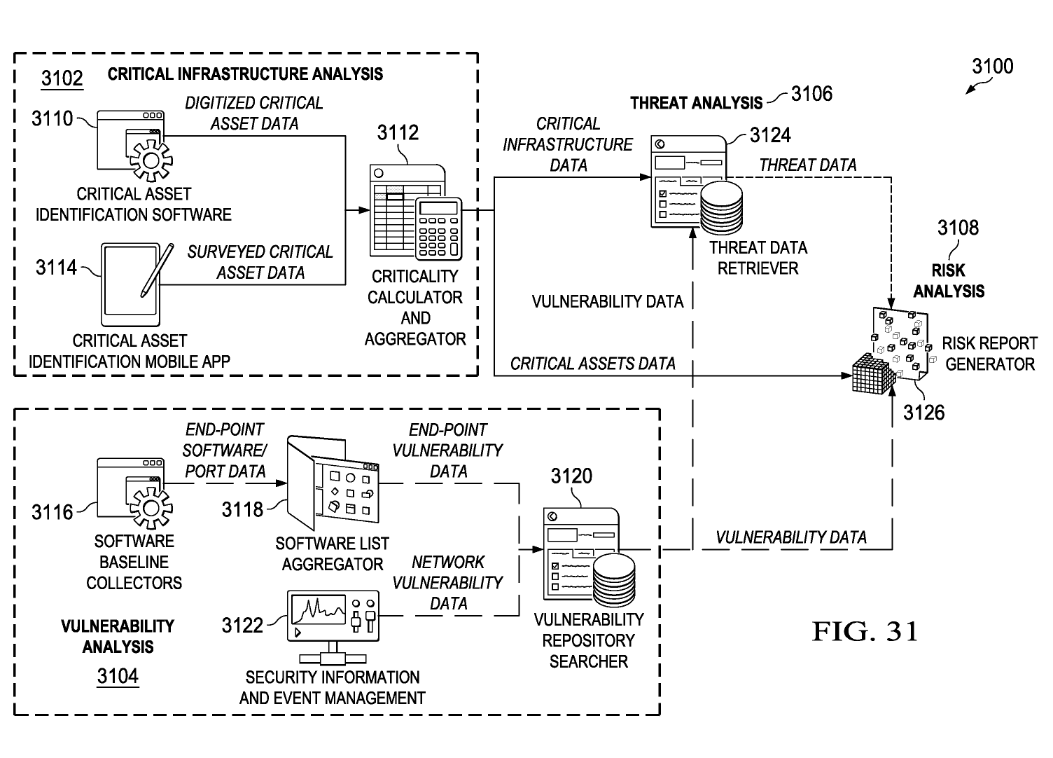

The major steps conducted through a VARM process are supported by the software architecture 3100 depicted in FIG. 31. The critical infrastructure analysis system 3102 is used to capture critical assets identification data and to calculate the criticality associated with such assets. The vulnerability analysis system 3104 identifies cyber vulnerabilities on the CCAs' installed software, communication ports, and in the infrastructure's OT network. The threat analysis system 3106 retrieves and analyzes historical threat trend data to assess the likelihood of threat. The risk analysis system 3108 aggregates the data obtained from the previously described analysis steps and combine them into a series of risk mitigation graphs. Some of the architecture systems are composed of one or more modules that interact with each other to accomplish the intended functionalities. The descriptions of such modules are provided below.

The critical infrastructure analysis subsystem 3102 is composed of three software components. The descriptions and functionalities of the components are provided below.

The critical assets identification software (CAI-S) 3110 allows users to identify critical information technology and operational technology assets on an infrastructure given a digital document depicting such infrastructure. The CAI-S 3110 takes as input a digital document, and allows a user to mark specific areas of the document and to create cyber-security metadata specific to the marked area. The created metadata supports the documentation and calculations required to determine the criticality of an asset. Once the document is marked down, and the metadata created, the results can be exported from this tool in a format readable by the criticality calculator and aggregator software tool 3112.

The critical assets identification mobile application (CAI-MA) 3114 allows users to capture criticality and identification data as a physical walkthrough is conducted through the infrastructure. The CAI-MA 3114 captures criticality data associated with the possible impact on human well-being, economic cost, and mission and operation. In addition, the application allows practitioners to capture asset identification data such as asset location, owner, and relation to other components. Once all of the critical assets data are collected, the CAI-MA 3114 can export the data into a format readable by the criticality calculator and aggregator software tool 3312.

The criticality calculator and aggregator (CCA) system 3112 is used to aggregate the criticality data obtained through the CAI-S 3110 and the CAI-MA 3114 software. The CCA 3112 takes as input CAI-S 3110 and CAI-MA 3114 generated files and interprets and stores the data contained in such files. The CCA 3112 then allows users to conduct criticality calculations on the data to rank, in order of criticality, the assets analyzed with the CAI-S 3110 and the CAI-MA 3114 tools. Once the data are aggregated and the criticality calculated, the CCA 3112 generates critical infrastructure data and critical assets data. The critical infrastructure data are the general description of the state of the enterprise in terms of criticality and details the sector to which the evaluated infrastructure belongs. The critical assets data capture the criticality metric values specific to each critical asset. Critical infrastructure data are used as input to the threat data retriever, and the risk report generator uses the critical asset data. The critical infrastructure data and critical assets data are further use as input to create a criticality interconnection map for the enterprise being evaluated.

The vulnerability analysis system 3104 is composed of four software components. The descriptions and functionalities of the subsystems are provided below.

The software baseline collectors 3116 are a set of programs that collect information about the identified critical cyber assets. The software baseline collectors 3116 gather a list of installed software and operating systems, security protocols, and communication interfaces ports associated with the critical cyber assets of interest. The collectors generate a list of potential vulnerable software and communication ports. The generated lists are combined by the software list aggregator 3118 and are later verified by the vulnerability repository searcher 3120.

The software list aggregator 3118 combines the lists obtained through the baseline collectors 3116 and creates a cyber-security profile of possible vulnerable software, operating system and communication ports in the critical cyber assets. The vulnerability repository searcher 3120 uses the profile to identify true cyber vulnerabilities in the critical infrastructure.

The security information and event management (SIEM) system 3122 is used to monitor the network connecting the critical cyber assets. The concept of a SIEM system 3122 is used in this work to represent network analysis tools, penetration-testing exercises, and SIEM systems 3122 used to monitor for anomalous traffic in the network. The SIEM 3122 outputs a list of suspicious network traffic, open ports and software that might be vulnerable to threat agents.

The vulnerability repository searcher 3120 takes as input a set of lists of software, operating systems, open communication ports, and suspicious network traffic, and allows a user to search in national vulnerability databases for reported vulnerabilities applicable to any of the elements in the lists. Given that the information is obtained from established data repositories, the results provide vulnerabilities names, descriptions, and scores based on the Common Vulnerability Scoring System (CVSS) [19]. In addition, the retrieved data also provides a breakdown of the type of attacks that the vulnerabilities are prone to.

The threat analysis subsystem 3106 is composed of one software component. The description and functionality of the subsystem is provided below.

The threat data retriever (TDR) 3124 helps users to identify threat sources and to determine the likelihood of such threatening sources perpetrating an attack on the critical cyber assets of interest. The TDR 3124 uses critical cyber asset data and vulnerability data to determine the likelihood of the attacks. The critical infrastructure data are used to identify the specific sector to which the infrastructure belongs, and the vulnerability data, that includes the breakdown of the type of attacks that the vulnerabilities are prone, are used to determine the specific vulnerabilities that might be attacked.

To determine the likelihood of the attack, the TDR 3124 retrieves data from different cyber-security agencies, including governmental, and determines the likelihood of an attack to the sector of interest. Then, the TDR 3124 identifies what are the threat actors that would be interested in attacking the sector of interest, and once those are identified, then the TDR 3124 populate a list of the type of attacks that such threat actors are using or have previously used. Given the list of attack types, the TDR 3124 allows a user to associate such attacks with the vulnerabilities, and based on the mapping between the attacks and the vulnerabilities, along with the sector cyber-security state, a likelihood value for an attack is calculated. In addition to numerical analysis, the TDR 3124 also provides graphical representation of the distributions of threat actors, sector's threatening conditions, and most frequently occurring cyber-attacks applicable to the infrastructure.

The risk analysis subsystem 3108 is composed of one software component. The description and functionality of the subsystem is provided below.

The risk report generator (RRG) 3126 allows users to generate risk reports based on the data collected and analyzed by the different tools used through the process. The RRG 3126 provides a template document that populates its different sections with the collected data. The report provides an overview of the ranked criticality assets, the most critical vulnerabilities identified through the infrastructure, and a threat analysis that can help the report's recipient to determine the risk associated with the infrastructure's critical components and to allocate resources accordingly. In addition, the RRG 3126 also generates the risk mitigation graphs using the data collected through the various steps of the VARM process.

It will be understood by those of skill in the art that information and signals may be represented using any of a variety of different technologies and techniques (e.g., data, instructions, commands, information, signals, bits, symbols, and chips may be represented by voltages, currents, electromagnetic waves, magnetic fields or particles, optical fields or particles, or any combination thereof). Likewise, the various illustrative logical blocks, modules, circuits, and algorithm steps described herein may be implemented as electronic hardware, computer software, or combinations of both, depending on the application and functionality. Moreover, the various logical blocks, modules, and circuits described herein may be implemented or performed with a general purpose processor (e.g., microprocessor, conventional processor, controller, microcontroller, state machine or combination of computing devices), a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. Similarly, steps of a method or process described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. Although preferred embodiments of the present invention have been described in detail, it will be understood by those skilled in the art that various modifications can be made therein without departing from the spirit and scope of the invention as set forth in the appended claims.

### REFERENCES

[1] Gallegos I. “Near Real-Time Risk Analysis of National Power Critical Infrastructure,” National Science Foundation Proposal, 2012.
[2] McDonald D. J. “Electric Power Substations Engineering,” Second Edition, 2007.
[3] American Petroleum Institute, “Security Vulnerability Assessment Methodology for the Petroleum and Petrochemical Industries,” Second Edition, October 2004.
[4] Stoneburner G., Goguen A., Fering a A. “Risk Management Guide for Information Technology Systems,” NIST Special Publication 800-30, July 2002.
[5] Silva J. C. “Modeling Threat Assessments of Water Supply Systems Using Markov Latent Effects Methodology,” Sandia Report SAND2006-7588, December 2006.
[6] Mell P, Scarfone K, Romanosky. “The Common Vulnerability Scoring System (CVSS) and its Applicability to Federal Agency Systems,” NISTIR 7435, August 2007.
[7] Weiss J. “Protecting Industrial Control Systems from Electronic Threats,” First Edition, May 2010.
[8] Fire Program Analysis (FPA) Project. (Nov. 5, 2012). http://www.fpa.nifc.gov/Library/Documentation/FPA_PM_Reference_Information/Output/GIS_overview.html.
[9] United States Computer Emergency Readiness Team (US-CERT). “About Us,” (Nov. 5, 2012). http://www.us-cert.gov/about.
[10] National Institute of Standards and Technology. “Guide for Conducting Risk Assessments,” September 2011.
[11] Smart Grid Interoperability Panel-Cyber Security Working Group, “Guidelines for Smart Grid Cyber Security: Vol. 3, Supportive Analysis and References,” August 2010.
[12] Sorebo N. G, Echols C. M. “Smart Grid Security: An End-to-End View of Security in the New Electrical Grid,” 2012.
[13] Flick T., Morehouse J. “Securing the Smart Grid: Next Generation Power Grid Security,” 2011.
[14] Department of Homeland Security, “Risk Management Fundamentals,” April 2011.
[15] North American Electric Reliability Council, “Risk-Assessment Methodologies for Use in the Electric Utility Industry,” 2005.
[16] Sandia National Labs, “A Risk Assessment Methodology (RAM) for Physical Security,” (Nov. 5, 2012). http://www.sandia.gov/ram/RAM%20White%20 Paper.pdf.
[17] Office of Science U.S. Department of Energy, “Cyber Security Threat Statement,” Jun. 6, 2007.
[18] Dagle J. “Vulnerability Assessment Activities,” Pacific Northwest National Laboratory, 2001.
[19] Goertzel M. K. “Information Assurance Tools Report Vulnerability Assessment,” Sixth Edition, May 2, 2011.
[20] Searle J. “Penetration Test Plans,” National Electric Sector Cybersecurity Organization Resource Version 2.0, 2012.
[21] SGIP CSWG Test & Certification Subgroup, “Guide for Assessing the High-Level Security Requirements in NISTIR 7628, Guidelines for Smart Grid Cyber Security,” Version 1.0, Aug. 24, 2012.
[22] Gartner IT Glossary, “Operational Technologies,” (Nov. 5, 2012). http://www.gartner.com/it-glossary/operational-technologies/.
[23] Podmore R., Becker D., Fairchild R. and Robinson M. “Common Information Model A Developer's Perspective,” in 32nd Hawaii International Conference on System Sciences, Hawaii, 1999.
[24] Govindarasu M., Hann A., Sauer P. “Cyber-Physical Systems Security for Smart Grid,” PSERC Publication, February 2012.
[1N] SGIP-Cyber Security Working Group, “Guidelines for Smart Grid Cyber Security: Vol. 1, Smart Grid Cyber Security Strategy, Architecture and High-Level Requirements,” NISTIR 7628, August 2010.
[2N] Gartner IT Glossary, “Operational Technologies,” (Sep. 25, 2013). http://www.gartner.com/it-glossary/operational-technology-ot/
[3N] Stoneburner G., Goguen A., Feringa A. “Risk Management Guide for Information Technology Systems,” NIST Special Publication 800-30, July 2002.
[4N] Stouffer K., Falco J., Scarfone K. “Guide to Industrial Control Systems (ICS) Security,” NIST Special Publication 800-82, June 2011.
[5N] International Society of Automation. “Security for Industrial Automation and Control Systems,” ANSI/ISA-99.00.01, Oct. 29, 2007.
[6N] Gallegos I. “Near Real-Time Risk Analysis of National Power Critical Infrastructure,” National Science Foundation Proposal, 2012.
[7N] Weiss J. “Protecting Industrial Control Systems from Electronic Threats,” First Edition, May 2010.
[8N] McDonald D. J. “Electric Power Substations Engineering,” Second Edition, 2007.
[9N] Wikipedia, “IP address,” (Sep. 25, 2013). http://en.wikipedia.org/wiki/IP_address
[10N] Smart Grid Interoperability Panel-Cyber Security Working Group, “Guidelines for Smart Grid Cyber Security: Vol. 3, Supportive Analysis and References,” August 2010.
[11]N] Common Vulnerabilities and Exposures, (Sep. 26, 2013). http://cve.mitre.org/
[12N] Common Weakness Enumeration, (Sep. 26, 2013). http://cwe.mitre.org/
[13N] The Open Web Application Security Project (OWASP), (Sep. 26, 2013). http://www.owasp.org/index.php/Main_Page
[14N] Passeri, Paulo. “Hachmageddon.com, I know with what weapons World War III will be fought.” [ONLINE] http://hackmageddon.com. 2013
[15N] MITRE. “Common Vulnerabilities and Exposures, The Standard for Information Security Vulnerability Names.” [ONLINE] http://cve.mitre.org. 2013
[16N] Sandia National Labs, “A Risk Assessment Methodology (RAM) for Physical Security,” (Nov. 5, 2012). http://www.sandia.gov/ram/RAM%20White%20Paper.pdf
[17N] Department of Homeland Security, “Risk Management Fundamentals,” April 2011.
[18N] Mell P, Scarfone K, Romanosky. “The Common Vulnerability Scoring System (CVSS) and its Applicability to Federal Agency Systems,” NISTIR 7435, August 2007.

What is claimed is:

1. A computerized method for assessing a risk of one or more assets within an operational technology infrastructure comprising the steps of:
providing a database containing data relating to the one or more assets;
calculating a threat score for the one or more assets using one or more processors communicably coupled to the database;
calculating a vulnerability score for the one or more assets using the one or more processors;
calculating an impact score for the one or more assets using the one or more processors; and
determining the risk of the one or more assets based on the threat score, the vulnerability score and the impact score using the one or more processors.

2. The method as recited in claim 1, further comprising the step of identifying the one or more assets within the operational technology infrastructure.

3. The method as recited in claim 1, further comprising the step of determining whether the one or more assets are a critical asset, a critical-cyber asset or a non-critical asset.

4. The method as recited in claim 1, wherein the one or more assets comprise cyber assets and physical assets.

5. The method as recited in claim 1, wherein the operational technology infrastructure comprises a utility infrastructure.

6. The method as recited in claim 1, further comprising the step of identifying and evaluating one or more risk management strategies to lower the risk of the one or more assets.

7. The method as recited in claim 1, wherein the threat score is based on a threat impact score and a likelihood & system effectiveness score.

8. The method as recited in claim 7, wherein the threat impact score is based on an intent value, a motivation value and a capability value.

9. The method as recited in claim 7, wherein the likelihood & system effectiveness score is based on a likelihood value, and a system effectiveness value.

10. The method as recited in claim 1, further comprising the steps of:
identifying one or more potential threat-sources;
characterizing the one or more potential threat-sources; and
selecting and adding the one or more assets and the one or more potential threat-sources as a matched pair to a threat/asset list.

11. The method as recited in claim 1, wherein the vulnerability score is based on an impact value, an exploitability value, a confidentiality value, an integrity value and an availability value.

12. The method as recited in claim 10, wherein the exploitability value is based on an access vector value, an access complexity value and an authentication value.

13. The method as recited in claim 1, further comprising the steps of:
identifying one or more vulnerability sources related to the one or more assets;
developing an asset and vulnerability scenario;
determining whether the asset and vulnerability scenario is credible; and
performing a system security test based on the asset and vulnerability scenario.

14. The method as recited in claim 1, wherein the impact score is based on a criticality value, a threat value and a vulnerability value.

15. The method as recited in claim 14, wherein the criticality value is based on a death impact value, a repair cost value and an economic disruption value.

16. The method as recited in claim 1, further comprising the step of generating a report containing the risk of the one or more assets.

17. A computer program embodied on a non-transitory computer readable medium for assessing a risk of one or more assets within an operational technology infrastructure comprising:
a code segment for calculating a threat score for the one or more assets;
a code segment for calculating a vulnerability score for the one or more assets;
a code segment for calculating an impact score for the one or more assets; and
a code segment for determining the risk of the one or more assets based on the threat score, the vulnerability score and the impact score.

18. An apparatus for assessing a risk of one or more assets within an operational technology infrastructure comprising:
a database containing data relating to the one or more assets; and
one or more processors communicably coupled to the database, wherein the one or more processors calculate a threat score for the one or more assets, calculate a vulnerability score for the one or more assets, calculate an impact score for the one or more assets, and determine the risk of the one or more assets based on the threat score, the vulnerability score and the impact score.

19. The apparatus as recited in claim 18, wherein the one or more processors further identify the one or more assets within the operational technology infrastructure.

20. The apparatus as recited in claim 18, wherein the one or more processors further determine whether the one or more assets are a critical asset, a critical-cyber asset or a non-critical asset.

21. The apparatus as recited in claim 18, wherein the one or more assets comprise cyber assets and physical assets.

22. The apparatus as recited in claim 18, wherein the operational technology infrastructure comprises a utility infrastructure.

23. The apparatus as recited in claim 18, wherein the one or more processors further identify and evaluate one or more risk management strategies to lower the risk of the one or more assets.

24. The apparatus as recited in claim 18, wherein the threat score is based on a threat impact score and a likelihood & system effectiveness score.

25. The apparatus as recited in claim 24, wherein the threat impact score is based on an intent value, a motivation value and a capability value.

26. The apparatus as recited in claim 24, wherein the likelihood & system effectiveness score is based on a likelihood value, and a system effectiveness value.

27. The apparatus as recited in claim 18, wherein the one or more processors further:
identify one or more potential threat-sources;
characterize the one or more potential threat-sources; and
select and adding the one or more assets and the one or more potential threat-sources as a matched pair to a threat/asset list.

28. The apparatus as recited in claim 18, wherein the vulnerability score is based on an impact value, an exploitability value, a confidentiality value, an integrity value and an availability value.

29. The apparatus as recited in claim 28, wherein the exploitability value is based on an access vector value, an access complexity value and an authentication value.

30. The apparatus as recited in claim 18, wherein the one or more processors further:
identify one or more vulnerability sources related to the one or more assets;
develop an asset and vulnerability scenario;
determine whether the asset and vulnerability scenario is credible; and
perform a system security test based on the asset and vulnerability scenario.

31. The apparatus as recited in claim 18, wherein the impact score is based on a criticality value, a threat value and a vulnerability value.

32. The apparatus as recited in claim 31, wherein the criticality value is based on a death impact value, a repair cost value and an economic disruption value.

33. The apparatus as recited in claim 18, wherein the one or more processors further generate a report containing the risk of the one or more assets.

34. A system for assessing a risk of one or more assets within an operational technology infrastructure comprising:
a risk assessment subsystem that calculates a threat score for the one or more assets, calculates a vulnerability score for the one or more assets, calculates an impact score for the one or more assets, and determines the risk of the one or more assets based on the threat score, the vulnerability score and the impact score;
a risk visualization subsystem;
a risk mitigation subsystem; and
a controller communicably coupled to the risk assessment subsystem, the risk visualization subsystem and the risk mitigation subsystem.

35. The system as recited in claim 34, wherein the risk assessment subsystem further comprises:
an impact analysis system;
a threat analysis system communicably coupled to the impact analysis system;
a vulnerability analysis system communicably coupled to the impact analysis system;
a critical infrastructure analysis system communicably coupled to the impact analysis system, the threat analysis system and the vulnerability analysis system; and
a risk analysis system communicably coupled to the threat analysis system, the critical infrastructure analysis system and the vulnerability system

36. The system as recited in claim 34, wherein the risk assessment subsystem further identifies the one or more assets within the operational technology infrastructure.

37. The system as recited in claim 34, wherein the risk assessment subsystem further determines whether the one or more assets are a critical asset, a critical-cyber asset or a non-critical asset.

38. The system as recited in claim 34, wherein the one or more assets comprise cyber assets and physical assets.

39. The system as recited in claim 34, wherein the operational technology infrastructure comprises a utility infrastructure.

40. The system as recited in claim 34, wherein the risk assessment subsystem further identifies and evaluates one or more risk management strategies to lower the risk of the one or more assets.

41. The system as recited in claim 34, wherein the threat score is based on a threat impact score and a likelihood & system effectiveness score.

42. The system as recited in claim 41, wherein the threat impact score is based on an intent value, a motivation value and a capability value.

43. The system as recited in claim 41, wherein the likelihood & system effectiveness score is based on a likelihood value, and a system effectiveness value.

44. The system as recited in claim 34, wherein the risk assessment subsystem further:
identifies one or more potential threat-sources;
characterizes the one or more potential threat-sources; and
selects and adds the one or more assets and the one or more potential threat-sources as a matched pair to a threat/asset list.

45. The system as recited in claim 34, wherein the vulnerability score is based on an impact value, an exploitability value, a confidentiality value, an integrity value and an availability value.

46. The system as recited in claim 45, wherein the exploitability value is based on an access vector value, an access complexity value and an authentication value.

47. The system as recited in claim 34, wherein the risk assessment subsystem further:
identifies one or more vulnerability sources related to the one or more assets;
develops an asset and vulnerability scenario;
determines whether the asset and vulnerability scenario is credible; and
performs a system security test based on the asset and vulnerability scenario.

48. The system as recited in claim 34, wherein the impact score is based on a criticality value, a threat value and a vulnerability value.

49. The system as recited in claim 48, wherein the criticality value is based on a death impact value, a repair cost value and an economic disruption value.
